(19) United States
(12) Patent Application Publication
(10) Pub. No.: US 2017/0223568 A1
(43) Pub. Date: Aug. 3, 2017

(54) Method and Apparatus for Triggering Buffer Status Report and Communications System

(71) Applicant: FUJITSU LIMITED, Kawasaki-shi (JP)

(72) Inventors: Haibo XU, Beijing (CN); Lianhai WU, Beijing (CN)

(73) Assignee: FUJITSU LIMITED, Kawasaki-shi (JP)

(21) Appl. No.: 15/491,070

(22) Filed: Apr. 19, 2017

Related U.S. Application Data
(63) Continuation of application No. PCT/CN2014/089479, filed on Oct. 24, 2014.

(51) Int. Cl. H04W 28/02; H04W 72/10; H04W 76/02

(52) U.S. Cl. CPC H04W 28/0278; H04W 76/021; H04W 72/10; H04W 88/02

(57) ABSTRACT

A method and apparatus for triggering a buffer status report and a communications system. The method includes: in a case where one or more radio access bearer(s) of user equipment based on an infrastructure mode is(are) converted into radio bears based on a device to device (D2D) communications mode and there exist available data to be transmitted in the PDCP entity or the RLC entity to which the at least one radio bearer based on the D2D communications mode corresponds, triggering a buffer status report for the D2D communications. Hence, the buffer status report for the D2D communications may be triggered or may be timely triggered, thereby avoiding a problem that the base station side is unable to obtain or unable to timely obtain data amounts of the D2D communications.

### CROSS REFERENCE TO RELATED APPLICATIONS

This application is a continuation application of International Application PCT/CN2014/089479 filed on Oct. 24, 2014, the entire contents of which are incorporated herein by reference.

### TECHNICAL FIELD

The present disclosure relates to the field of communications technologies, and in particular to a method and apparatus for triggering a buffer status report and a communications system.

### BACKGROUND

Currently, in a long-term evolution (LTE) system, communications between user equipment (UE) need to be performed in a radio access network and a core network. As appearance of demands for many new traffics, and at the same time, in order to reduce a load of a network and achieve transfer of the load of the network, device to device (D2D) communications has gradually become a new direction for studies. When a distance between two pieces of UE is sufficiently near, the UE may discover existence of the counterpart, hence, D2D direct communications may be performed under control of a base station.

The D2D communications may be performed in a broadcast/multicast manner, i.e., point to multipoint communications, and may also be performed in a unicast manner, i.e., point to point communications. For the unicast manner, a scenario needing to taken into account is: a communications mode of a traffic may possibly be converted between an infrastructure mode (or an infrastructure path) and a D2D communications mode (i.e., ProSe communications mode or ProSe communications path).

FIG. 1 shows a schematic diagram of a scenario before a communications mode of a traffic is converted. As shown in FIG. 1, before being converted, UE 1 has traffic communications with UE 2 and UE 3 at the same time, and both communications modes are infrastructure modes (that is, UE→base station→core network→base station→UE).

As shown in FIG. 1, an E-RAB (EUTRA-radio access bearer) 1 is established between UE 1 and UE 2, the E-RAB including an S1 bearer 1 in an S1 interface (i.e., an interface between a base station and an SGW/a PGW) and a data radio bearer (DRB) 1 in an air interface (i.e., an interface between a base station and UE). And E-RAB 2 is established between UE 1 and UE 3, the E-RAB including an S1 bearer 2 in the S1 interface and a DRB 2 in the air interface.

FIG. 2 shows a schematic diagram of a scenario after a communications mode of a traffic is converted. As shown in FIG. 2, after UE 1 and UE 2 complete D2D mutual discovery, a communications mode of the E-RAB 1 based on the infrastructure mode previously established between UE 1 and UE 2 is converted into a D2D communications mode, and a communications mode of the E-RAB 2 based on the infrastructure mode established between UE 1 and the UE 3 is unchanged. As shown in FIG. 2, a ProSe radio bearer (PRB) 1 based on the D2D communications mode is established between UE 1 and UE 2, the PRB 1 existing between UE 1 and UE 2.

Here, for the sake of simplicity of description, a D2D radio bearer based on the ProSe communications mode is referred to as a PRB. However, this disclosure is not limited thereto. For example, the radio bearer may also be referred to as a P-DRB or an SL(sidelink)-DRB. In order to realize D2D communications, two types of air-interface resource allocation schemes, mode 1 and mode 2, are defined in an LTE-A system.

The mode 1 is a resource allocation scheme scheduled by a base station, characterized in that:
in order to transmit data, the UE needs to be in an RRC CONNECTED status;
the UE requests the base station for transmission resources, and the base station schedules resources for the UE for transmitting scheduling allocation and data; and
in order to request for transmission resources, the UE transmits a scheduling request and a buffer status report (BSR) to the base station, and the base station may determine that the UE has data of D2D communications for transmission and an amount of data to be transmitted.

And the mode 2 is a resource allocation scheme in which the UE selects resources by itself, characterized in that:
the base station configures the UE with a resource pool; and
when the UE has data of D2D communications needing to be transmitted, the UE selects resources from the resource pool by itself to transmit scheduling allocation and data.

For example, in the mode 1, the UE needs to transmit buffer status reports (BSRs) to the base station, reporting data amounts of traffics using the D2D communications.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

Currently, in order to avoid an effect on transmission of a buffer status report regarding a traffic of a regular infrastructure mode, a buffer status report for D2D communications (which may be referred to as ProSe-BSR) mechanism is introduced, mainly including a triggering mechanism of new buffer status report, and an MAC (media access control) signaling format and content of the buffer status report. The triggering mechanism of the ProSe-BSR mainly follows the current regular triggering mechanism of BSR, mainly including following triggering conditions:

(1) a packet data convergence protocol (PDCP) entity or a radio link control (RLC) entity to which a logic channel in a logic channel group corresponds changes from having no available data for transmission to having available data for transmission, and a priority of the logic channel is higher than priorities of all logic channels belonging to any logic channel groups and having available data for transmission;

(2) an RLC entity or a PDCP entity to which a logic channel in a logic channel group corresponds changes from having no available data for transmission to having available data for transmission, and any other logic channel belonging to the logic channel group has no corresponding data for transmission;

(3) the number of bits that can be carried by an uplink resource allocated by a base station for UE is greater than or equal to the number of bits occupied by a ProSe-BSR MAC CE (control element) and an MAC subheader to which the MAC CE corresponds;

(4) a retxB SR-timer expires and at least one logic channel of the UE belonging to the logic channel group has available data for transmission; and

(5) a periodicBSR-timer expires.

Furthermore, there exists another possible triggering mechanism of the ProSe-BSR, i.e., after a resource allocation manner of the D2D communications used by the UE is converted from the mode 1 to the mode 2, a ProSe-BSR is triggered.

However, it was found by the inventors that in a case where D2D unicast communications is established, if conversion between the infrastructure communications mode and the D2D communications mode occurs, the current ProSe-BSR mechanism is unable to guarantee that the converted ProSe-B SR can be triggered or be timely triggered.

Embodiments of this disclosure provide a method and apparatus for triggering a buffer status report and a communications system, which are used to guarantee that a ProSe-BSR can be triggered or be timely triggered.

According to a first aspect of the embodiments of the present disclosure, there is provided a method for triggering a buffer status report (BSR), including:

in a case where one or more radio access bearer(s) of user equipment based on an infrastructure mode is(are) converted into radio bears based on a device to device (D2D) communications mode and a resource allocation manner configured by a base station for the user equipment in D2D communications is a resource allocation manner based on base station scheduling, determining that there exist available data to be transmitted in a packet data convergence protocol (PDCP) entity or a radio link control (RLC) entity to which at least one radio bearer in the one or more radio bearer(s) based on the D2D communications mode corresponds; and

in a case where there exist available data to be transmitted in the PDCP entity or the RLC entity to which the at least one radio bearer based on the D2D communications mode corresponds, triggering a BSR for the D2D communications.

According to a second aspect of the embodiments of the present disclosure, there is provided an apparatus for triggering a buffer status report (BSR), configured in user equipment, the apparatus including:

a determining unit configured to, in a case where one or more radio access bearer(s) of the user equipment based on an infrastructure mode is(are) converted into radio bears based on a device to device (D2D) communications mode and a resource allocation manner configured by a base station for the user equipment in D2D communications is a resource allocation manner based on base station scheduling, determine that there exist available data to be transmitted in a packet data convergence protocol (PDCP) entity or a radio link control (RLC) entity to which at least one radio bearer in the one or more radio bearer(s) based on the D2D communications mode corresponds; and

a reporting unit configured to, in a case where there exist available data to be transmitted in the PDCP entity or the RLC entity to which the at least one radio bearer based on the D2D communications mode corresponds, trigger a BSR for the D2D communication.

According to a third aspect of the embodiments of the present disclosure, there is provided a method for triggering a buffer status report (BSR), including:

in a case where one or more radio bearer(s) of the user equipment based on a D2D communications mode is(are) converted into radio access bearers based on an infrastructure mode and a resource allocation manner configured by a base station for the user equipment in D2D communications is a resource allocation manner based on base station scheduling, determining that the user equipment at least further has a radio bearer based on the D2D communications mode in which there exist available data to be transmitted; and

in a case where the user equipment at least further has a radio bearer based on the D2D communications mode in which there exist available data to be transmitted, triggering a BSR for the D2D communications.

According to a fourth aspect of the embodiments of the present disclosure, there is provided an apparatus for triggering a buffer status report (BSR), configured in user equipment, the apparatus including:

a determining unit configured to determine, in a case where one or more radio bearer(s) of the user equipment based on a D2D communications mode is(are) converted into radio access bearers based on an infrastructure mode and a resource allocation manner configured by a base station for the user equipment in D2D communications is a resource allocation manner based on base station scheduling, that the user equipment at least further has a radio bearer based on the D2D communications mode in which there exist available data to be transmitted; and

a reporting unit configured to, in a case where the user equipment at least further has a radio bearer based on the D2D communications mode in which there exist available data to be transmitted, trigger a BSR for the D2D communications.

According to a fifth aspect of the embodiments of the present disclosure, there is provided a communications system, including:

user equipment configured to, in a case where one or more radio access bearer(s) of the user equipment based on an infrastructure mode is(are) converted into radio bearers based on a D2D communications mode, a resource allocation manner configured by a base station for the user equipment in D2D communications is a resource allocation manner based on base station scheduling, and there exist available data to be transmitted in a PDCP entity or an RLC entity to which at least one radio bearer in the one or more radio bearer(s) based on the D2D communications mode corresponds, trigger a BSR for the D2D communications;

or, in a case where one or more radio bearer(s) of the user equipment based on the D2D communications mode is(are) converted into radio access bearers based on the infrastructure mode, a resource allocation manner configured by a base station for the user equipment in D2D communications is a resource allocation manner based on base station scheduling, and the user equipment at least further has a radio bearer based on the D2D communications mode in which there exist available data to be transmitted, trigger a BSR for the D2D communications.

According to another aspect of the embodiments of the present disclosure, there is provided a computer readable program code, which, when executed in UE, will cause a computer unit to carry out the method for triggering a buffer status report as described above in the UE.

According to a further aspect of the embodiments of the present disclosure, there is provided a computer readable medium, including a computer readable program code, which will cause a computer unit to carry out the method for triggering a buffer status report as described above in UE.

An advantage of the embodiments of the present disclosure exists in that if conversion between the infrastructure communications mode and the D2D communications mode occurs, the ProSe-BSR can be triggered or be timely triggered, thereby avoiding a problem that the base station side is unable to obtain or unable to timely obtain data amounts of the D2D communications.

With reference to the following description and drawings, the particular embodiments of the present disclosure are disclosed in detail, and the principle of the present disclosure and the manners of use are indicated. It should be understood that the scope of the embodiments of the present disclosure is not limited thereto. The embodiments of the present disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of a scenario before a communications mode of a traffic is converted;

FIG. 2 is a schematic diagram of a scenario after a communications mode of a traffic is converted;

FIG. 3 is a flowchart of the method for triggering a buffer status report of Embodiment 1 of this disclosure;

FIG. 4 is a flowchart of the method for triggering a buffer status report of Embodiment 1 of this disclosure;

FIG. 5 is a flowchart of the method for triggering a buffer status report of Embodiment 2 of this disclosure;

FIG. 6 is a schematic diagram of a scenario before a communications mode of a traffic is converted of Embodiment 2 of this disclosure;

FIG. 7 is a schematic diagram of a scenario after a communications mode of a traffic is converted of Embodiment 2 of this disclosure;

FIG. 8 is a flowchart of the method for triggering a buffer status report of Embodiment 3 of this disclosure;

FIG. 9 is a schematic diagram of a scenario before a communications mode of a traffic is converted of Embodiment 3 of this disclosure;

FIG. 10 is a schematic diagram of a scenario after a communications mode of a traffic is converted of Embodiment 3 of this disclosure;

FIG. 11 is a flowchart of the method for triggering a buffer status report of Embodiment 4 of this disclosure;

FIG. 12 is a schematic diagram of a scenario before a communications mode of a traffic is converted of Embodiment 4 of this disclosure;

FIG. 13 is a schematic diagram of a scenario after a communications mode of a traffic is converted of Embodiment 4 of this disclosure;

FIG. 14 is a flowchart of the method for triggering a buffer status report of Embodiment 5 of this disclosure;

FIG. 15 is a schematic diagram of a scenario before a communications mode of a traffic is converted of Embodiment 5 of this disclosure;

FIG. 16 is a schematic diagram of a scenario after a communications mode of a traffic is converted of Embodiment 5 of this disclosure;

FIG. 17 is a flowchart of the method for triggering a buffer status report of Embodiment 6 of this disclosure;

FIG. 18 is a schematic diagram of a scenario before a communications mode of a traffic is converted of Embodiment 6 of this disclosure;

FIG. 19 is a schematic diagram of a scenario after a communications mode of a traffic is converted of Embodiment 6 of this disclosure;

FIG. 20 is a flowchart of the method for triggering a buffer status report of Embodiment 7 of this disclosure;

FIG. 21 is a schematic diagram of a scenario before a communications mode of a traffic is converted of Embodiment 7 of this disclosure;

FIG. 22 is a schematic diagram of a scenario after a communications mode of a traffic is converted of Embodiment 7 of this disclosure;

FIG. 23 is a flowchart of the method for triggering a buffer status report of Embodiment 8 of this disclosure;

FIG. 24 is a schematic diagram of a scenario before a communications mode of a traffic is converted of Embodiment 8 of this disclosure;

FIG. 25 is a schematic diagram of a scenario after a communications mode of a traffic is converted of Embodiment 8 of this disclosure;

FIG. 26 is a flowchart of the method for triggering a buffer status report of Embodiment 9 of this disclosure;

FIG. 27 is a schematic diagram of a scenario before a communications mode of a traffic is converted of Embodiment 9 of this disclosure;

FIG. 28 is a schematic diagram of a scenario after a communications mode of a traffic is converted of Embodiment 9 of this disclosure;

FIG. 29 is a flowchart of the method for triggering a buffer status report of Embodiment 10 of this disclosure;

FIG. 30 is a schematic diagram of a scenario before a communications mode of a traffic is converted of Embodiment 10 of this disclosure;

FIG. 31 is a schematic diagram of a scenario after a communications mode of a traffic is converted of Embodiment 10 of this disclosure;

FIG. 32 is a flowchart of the method for triggering a buffer status report of Embodiment 11 of this disclosure;

FIG. 33 is a flowchart of the method for triggering a buffer status report of Embodiment 12 of this disclosure;

FIG. 34 is a schematic diagram of a structure of the apparatus for triggering a buffer status report of Embodiment 13 of this disclosure;

FIG. 35 is a schematic diagram of a structure of the communications system of Embodiment 15 of this disclosure; and

FIG. 36 is a block diagram of a systematic structure of the UE of Embodiment 15 of this disclosure.

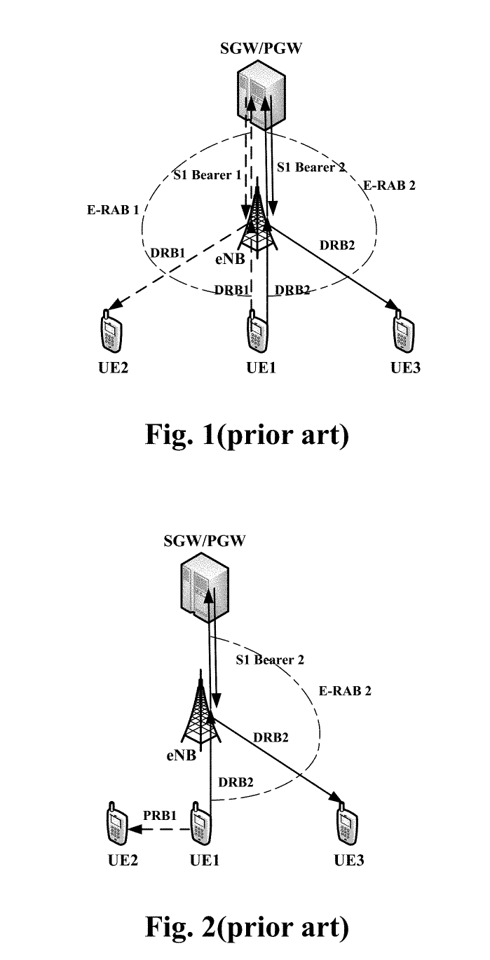

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments, a case where an infrastructure mode is converted into a D2D communications mode may occur, and a case where a D2D communications mode is converted into an infrastructure mode may also occur, which shall be described below by way of different embodiments.

### Embodiment 1

An embodiment of this disclosure provides a method for triggering a buffer status report, applicable to a case where one or more radio access bearer(s) of UE based on an infrastructure mode is/are converted into radio bearers based on a D2D communications mode.

In this embodiment, for example, following scenarios are taken into account:

UE 1 is communicating with UE 2 for a traffic (such a video traffic) by using the infrastructure mode; the base station configures the traffic with corresponding DRBs (including a PDCP entity, an RLC entity and a logic channel), and the logic channel belongs to a logic channel group; during the communications, the UE will transmit a BSR after a regular BSR triggering condition is satisfied.

At a certain moment, after the infrastructure communications satisfy a condition, they may be converted into the D2D communications. The condition may be, for example, that UE 1 and UE 2 mutually discover existence of the counterpart via a D2D discovery mechanism, or that the base station judges that UE 1 and UE 2 satisfy a D2D communications condition based on a measurement result reported by the UE. Thereafter, the communications mode of the traffic of UE 1 and UE 2 is converted into D2D communications.

After receiving signaling for configuring a communications mode to be converted from the base station, UE 1 and UE 2 will reestablish the PDCP entity and RLC entity of the radio bearer to which the traffic corresponds. Thereafter, parameter reconfiguration is performed on the PDCP entity and RLC entity of the radio bearer to which the traffic corresponds and the logic channel according to the configuration signaling received from the base station, that is, the PDCP entity, the RLC entity and the logic channel shall all be reconfigured into D2D communication-specific entities and logic channel. In a case where the UE has only one DRB, although after the mode conversion is finished, based on a regular BSR reported by the UE before the mode conversion, the base station may deduce a size of an amount of data waiting for being transmitted in a buffer of the PDCP entity and a buffer of the RLC entity of the radio bearer of the current D2D communications, following problems, for example, may possibly occur:

(1) after the amount of data of the radio bearer changes, the base station is unable to know its recent amount of data, since at the UE side, it is possible that the ProSe-BSR triggering condition cannot be satisfied forever; and

(2) when the UE has more than one DRBs and the DRBs belong to the same logic channel group, after a communications mode of a DRB is converted into the D2D communications mode, the base station is unable to deduce a size of an amount of data waiting for being transmitted in a buffer of the PDCP entity and a buffer of the RLC entity of the radio bearer of the current D2D communications based on the regular BSR reported by the UE before the mode conversion.

Hence, the base station is unable to obtain or unable to timely obtain such information as a data amount in the D2D communications mode, etc.

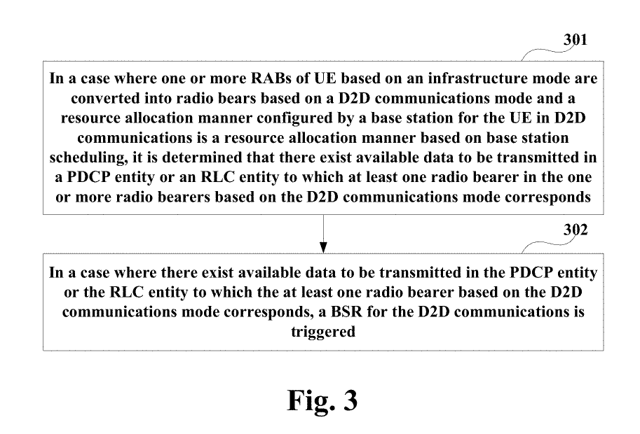

FIG. 3 is a flowchart of the method for triggering a buffer status report of the embodiment of this disclosure. As shown in FIG. 3, the method includes:

step 301: in a case where one or more radio access bearer(s) of user equipment based on an infrastructure mode is(are) converted into radio bears based on a device to device (D2D) communications mode and a resource allocation manner configured by a base station for the user equipment in D2D communications is a resource allocation manner based on base station scheduling, it is determined that there exist available data to be transmitted in a packet data convergence protocol (PDCP) entity or a radio link control (RLC) entity to which at least one radio bearer in the one or more radio bearer(s) based on the D2D communications mode corresponds; and

step 302: in a case where there exist available data to be transmitted in the PDCP entity or the RLC entity to which the at least one radio bearer based on the D2D communications mode corresponds, a BSR for the D2D communications is triggered.

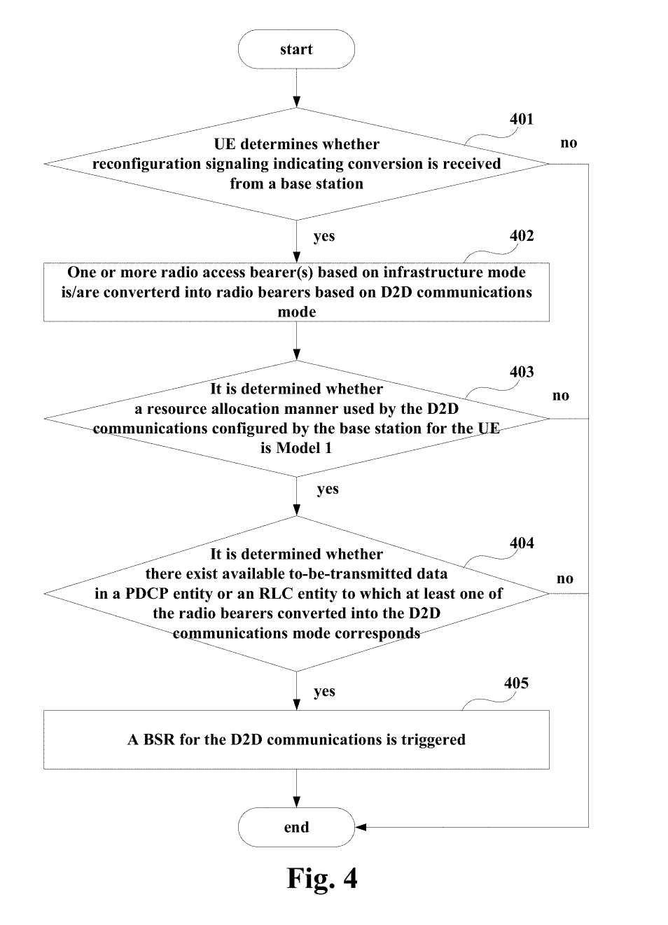

FIG. 4 is another flowchart of the method for triggering a buffer status report of Embodiment 1 of this disclosure. As shown in FIG. 4, the method includes:

step 401: the UE determines whether reconfiguration signaling for indicating conversion is received from the base station, the reconfiguration signaling indicating the UE to convert one or more radio access bearer(s) based on the infrastructure mode into radio bearers based on the D2D communications mode, and step 402 is executed if it is determined that the reconfiguration signaling is received;

step 402: the one or more radio access bearer(s) based on the infrastructure mode is(are) converted into radio bearers based on the D2D communications mode;

step 403: it is determined whether a resource allocation manner used by the D2D communications configured by the base station for the UE is a resource allocation manner based on scheduling of the base station, and step 404 is executed if it is determined that the resource allocation manner is a resource allocation manner based on scheduling of the base station, i.e., mode 1, otherwise, the method of this disclosure is terminated;

step 404: it is determined whether there exist available to-be-transmitted data in a PDCP entity or an RLC entity to which at least one of the one or more radio bearer(s) converted into the D2D communications mode corresponds, and step 405 is executed if there exist available to-be-transmitted data in a PDCP entity or an RLC entity to which at least one of the one or more radio bearer(s) converted into the D2D communications mode corresponds; and

step 405: a BSR for the D2D communications is triggered.

In this embodiment, if there exist available to-be-transmitted data in a PDCP entity or an RLC entity to which at least one of radio bearers converted into the D2D communications mode corresponds, the UE triggers the BSR for the D2D communications, i.e., a ProSe-BSR, which is referred to as a regular B SR. And in a case where the UE has no uplink resource, the ProSe-B SR triggers transmission of a scheduling request.

Hence, the ProSe-B SR may be triggered or timely triggered, and the base station side may obtain or timely obtain data amounts of the D2D communications.

### Embodiment 2

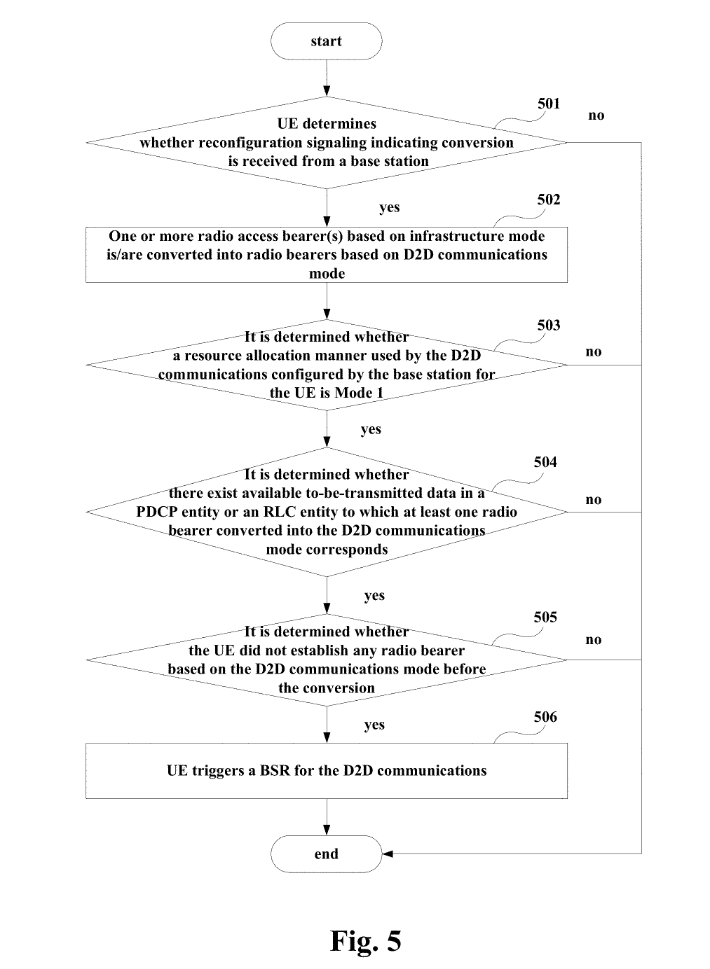

On the basis of Embodiment 1, an embodiment of this disclosure provides a method for triggering a buffer status report. FIG. 5 is a flowchart of the method for triggering a buffer status report of the embodiment of this disclosure. As shown in FIG. 5, the method includes:

step 501: the UE determines whether reconfiguration signaling for indicating conversion is received from the base station, the reconfiguration signaling indicating the UE to convert one or more radio access bearer(s) based on the infrastructure mode into radio bearers based on the D2D communications mode, and step 502 is executed if it is determined that the reconfiguration signaling is received;

step 502: the one or more radio access bearer(s) based on the infrastructure mode is(are) converted into radio bearers based on the D2D communications mode;

step 503: it is determined whether a resource allocation manner used by the D2D communications configured by the base station for the UE is a resource allocation manner based on scheduling of the base station, i.e., mode 1, and step 504 is executed if a result of the above determination is “yes”;

step 504: it is determined whether there exist available to-be-transmitted data in a PDCP entity or an RLC entity to which at least one radio bearer converted into the D2D communications mode corresponds, and step 505 is executed if there exist available to-be-transmitted data;

step 505: it is determined whether the UE did not establish any radio bearer based on the D2D communications mode before the conversion, and step 506 is executed if yes; and

step 506: the UE triggers a BSR for the D2D communications.

In this embodiment, in a case where one or more radio access bearer(s) based on the infrastructure mode of the UE are converted into the radio bearers based on the D2D communications mode and the resource allocation manner used by the D2D communications configured by the base station for the UE is the resource allocation manner based on scheduling of the base station, i.e., mode 1, if either one of the following conditions:

(1) there exist available to-be-transmitted data in a PDCP entity or an RLC entity to which at least one radio bearer converted into the D2D communications mode corresponds, and

(2) the UE did not establish any radio bearer based on the D2D communications mode before the conversion,

is not satisfied, the processing of this disclosure may be terminated. If both the above conditions (1) and (2) are satisfied, the UE triggers a BSR for the D2D communications, i.e., the ProSe-BSR, which is referred to as a regular BSR. And in a case where the UE has no uplink resource, the ProSe-BSR triggers transmission of a scheduling request.

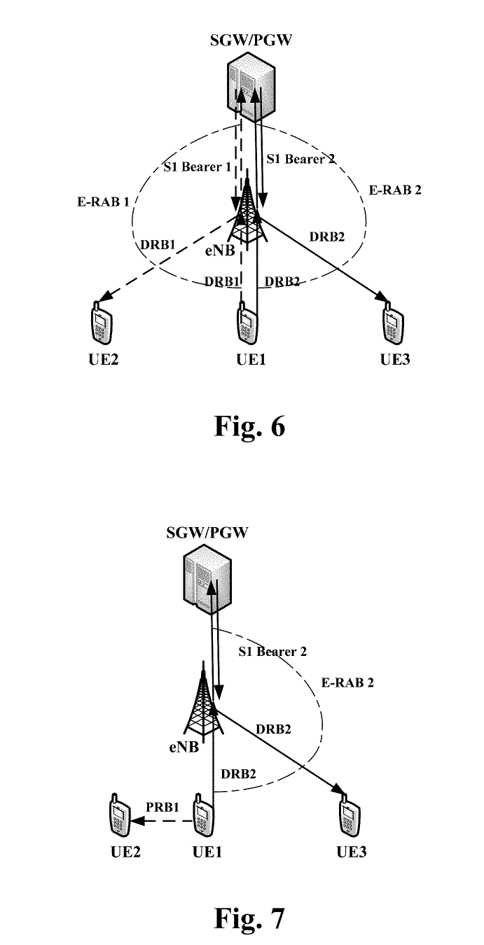

For example, FIG. 6 is a schematic diagram of a scenario before a communications mode of a traffic is converted of the embodiment of this disclosure, and FIG. 7 is a schematic diagram of a scenario after a communications mode of a traffic is converted of the embodiment of this disclosure. UE 1 shown in FIGS. 6 and 7 has an E-RAB 1 and an E-RAB 2 communicating based on the infrastructure mode. After E-RAB 1 is converted into PRB 1 communicating based on the D2D communications mode, if there exist available to-be-transmitted data in a PDCP entity or an RLC entity to which PRB 1 corresponds and PRB 1 is a first radio bearer based on the D2D communications mode of UE 1 (that is, the UE 1 did not establish any radio bearer based on the D2D communications mode before), UE 1 triggers the ProSe-BSR.

Hence, the ProSe-BSR may be triggered or timely triggered, and the base station side may obtain or timely obtain data amounts of the D2D communications.

### Embodiment 3

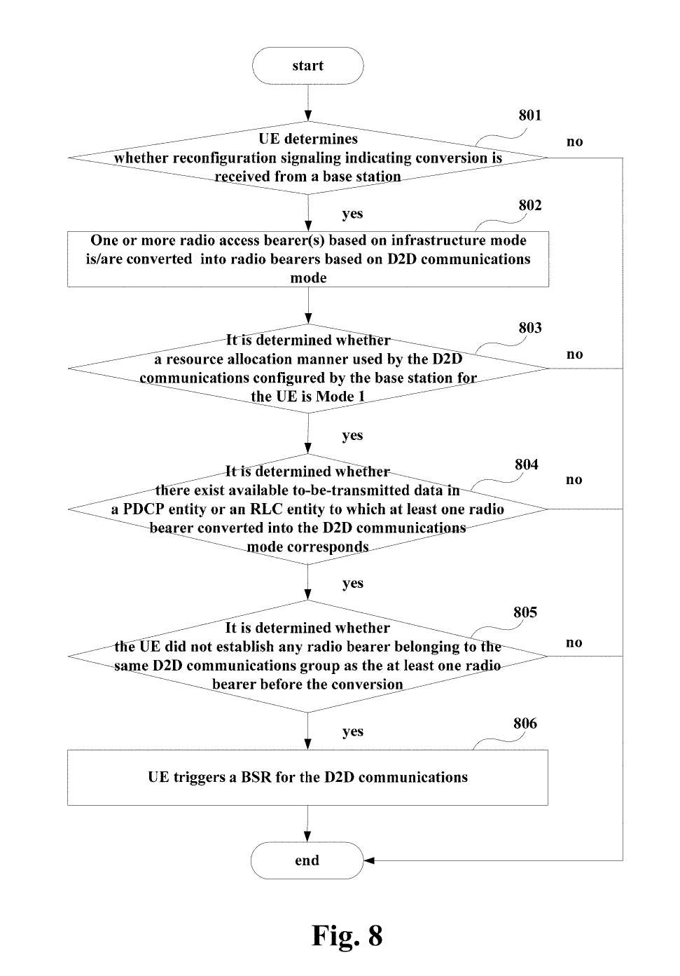

On the basis of Embodiment 1, an embodiment of this disclosure provides a method for triggering a buffer status report. FIG. 8 is a flowchart of the method for triggering a buffer status report of the embodiment of this disclosure. As shown in FIG. 8, the method includes:

step 801: the UE determines whether reconfiguration signaling for indicating conversion is received from the base station, the reconfiguration signaling indicating the UE to convert one or more radio access bearer(s) based on the infrastructure mode into radio bearers based on the D2D communications mode, and step 802 is executed if it is determined that the reconfiguration signaling is received;

step 802: the one or more radio access bearer(s) based on the infrastructure mode is(are) converted into radio bearers based on the D2D communications mode;

step 803: it is determined whether a resource allocation manner used by the D2D communications configured by the base station for the UE is a resource allocation manner based on scheduling of the base station, i.e., mode 1, and step 804 is executed if a result of the above determination is yes;

step 804: it is determined whether there exist available to-be-transmitted data in a PDCP entity or an RLC entity to which at least one radio bearer converted into the D2D communications mode corresponds, and step 805 is executed if there exist available to-be-transmitted data;

step 805: it is determined whether the UE did not establish any radio bearer belonging to the same D2D communications group as the at least one radio bearer converted into the D2D communications mode before the conversion, and step 806 is executed if yes; and

step 806: the UE triggers a BSR for the D2D communications.

In this embodiment, in a case where one or more radio access bearer(s) based on the infrastructure mode of the UE are converted into the radio bearers based on the D2D communications mode, if either one of the following conditions:

(1) there exist available to-be-transmitted data in a PDCP entity or an RLC entity to which at least one radio bearer converted into the D2D communications mode corresponds, and

(3) before the conversion, the UE did not establish any radio bearer belonging to the same D2D communications group as the at least one radio bearer converted into the D2D communications mode,

is not satisfied, the processing of this disclosure may be terminated. If both the above conditions (1) and (3) are satisfied, the UE triggers a BSR for the D2D communications, i.e., the ProSe-BSR, which is referred to as a regular BSR. And in a case where the UE has no uplink resource, the ProSe-BSR triggers transmission of a scheduling request.

The D2D communications group may be a combination of multiple pieces of UE performing D2D communications. For example, if some traffics between UE 1 and UE 2 perform D2D communications, UE 1 and UE 2 may be deemed as belonging to the same D2D communications group, which, for example, may be deemed as ProSe Group 1. And at the same time, if some traffics between UE 1 and UE 3 also perform D2D communications, UE 1 and UE 3 may be deemed as belonging to the same D2D communications group, which, for example, may be deemed as ProSe Group 2.

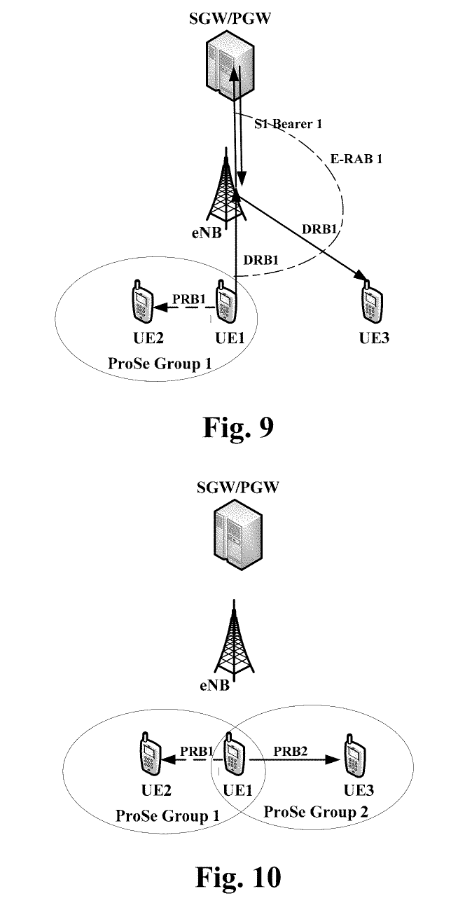

For example, FIG. 9 is a schematic diagram of a scenario before a communications mode of a traffic is converted of the embodiment of this disclosure, and FIG. 10 is a schematic diagram of a scenario after a communications mode of a traffic is converted of the embodiment of this disclosure. As shown in FIGS. 9 and 10, UE 1 and UE 3 have an E-RAB 1 performing infrastructure communications, and at the same time, UE 1 and UE 2 have a PRB 1 performing D2D communications, and UE 1 and UE 2 belong to D2D communications group 1, i.e., ProSe Group 1.

After the communications mode of the radio access bearer E-RAB 1 between UE 1 and UE 3 is converted from the infrastructure mode to the D2D communications mode, UE 1 and UE 3 form a new D2D communications group, i.e., ProSe Group 2. After E-RAB 1 is converted PRB 2 performing D2D communications, if there exist available to-be-transmitted data in a PDCP entity or an RLC entity to which PRB 2 corresponds and PRB 2 is a first radio bearer communicating based on the D2D communications mode in the D2D communications group, i.e., ProSe Group 2, formed by UE 1 and UE 3 (that is, no radio bearer based on the D2D communications mode was established before in ProSe Group 2), UE 1 triggers the ProSe-BSR.

Hence, the ProSe-BSR may be triggered or timely triggered, and the base station side may obtain or timely obtain data amounts of the D2D communications.

### Embodiment 4

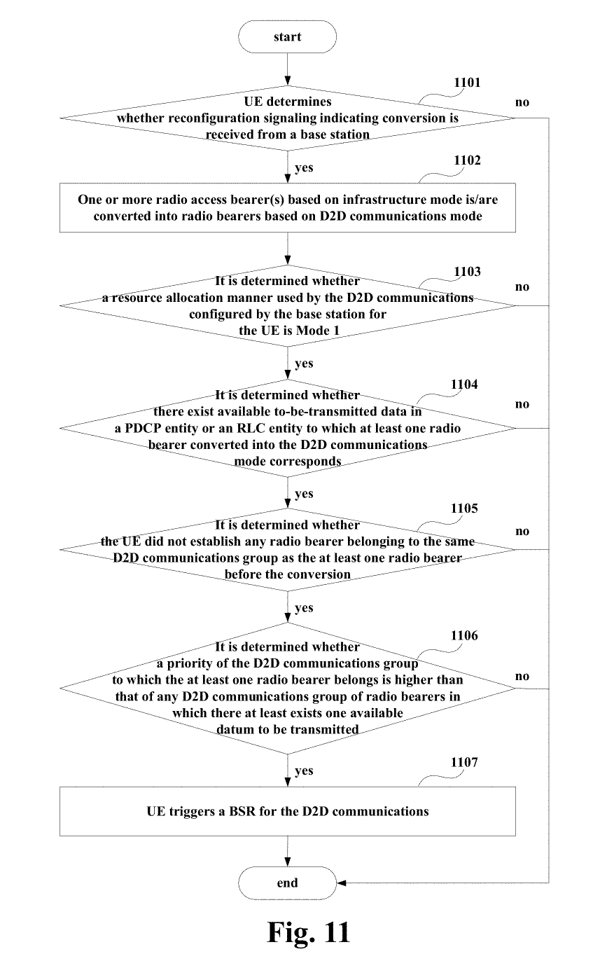

On the basis of Embodiment 1, an embodiment of this disclosure provides a method for triggering a buffer status report. FIG. 11 is a flowchart of the method for triggering a buffer status report of the embodiment of this disclosure. As shown in FIG. 11, the method includes:

step 1101: the UE determines whether reconfiguration signaling for indicating conversion is received from the base station, the reconfiguration signaling indicating the UE to convert one or more radio access bearer(s) based on the infrastructure mode into radio bearers based on the D2D communications mode, and step 1102 is executed if it is determined that the reconfiguration signaling is received;

step 1102: the one or more radio access bearer(s) based on the infrastructure mode is(are) converted into radio bearers based on the D2D communications mode;

step 1103: it is determined whether a resource allocation manner used by the D2D communications configured by the base station for the UE is a resource allocation manner based on scheduling of the base station, i.e., mode 1, and step 1104 is executed if a result of the above determination is yes;

step 1104: it is determined whether there exist available to-be-transmitted data in a PDCP entity or an RLC entity to which at least one radio bearer converted into the D2D communications mode corresponds, and step 1105 is executed if there exist available to-be-transmitted data;

step 1105: it is determined whether the UE did not establish any radio bearer belonging to the same D2D communications group as the at least one radio bearer converted into the D2D communications mode before the conversion, and step 1106 is executed if yes;

step 1106: it is determined whether a priority of the D2D communications group to which the at least one radio bearer based on the D2D communications mode belongs is higher than that of any D2D communications group of radio bearers based on the D2D communications mode in which there at least exists one available datum to be transmitted, and step 1107 is executed if yes; and

step 1107: the UE triggers a BSR for the D2D communications.

In this embodiment, in a case where one or more radio access bearer(s) based on the infrastructure mode of the UE are converted into the radio bearers based on the D2D communications mode, in addition to that the above conditions (1) and (3) are satisfied, the following condition should also be satisfied:

(4) the priority of the D2D communications group to which the at least one radio bearer converted into the D2D communications mode belongs is higher than that of any D2D communications group of radio bearers based on the D2D communications mode in which there at least exists one available datum to be transmitted.

And the UE triggers the BSR for the D2D communications, i.e., the ProSe-BSR, which is referred to as a regular B SR. And in a case where the UE has no uplink resource, the ProSe-B SR triggers transmission of a scheduling request.

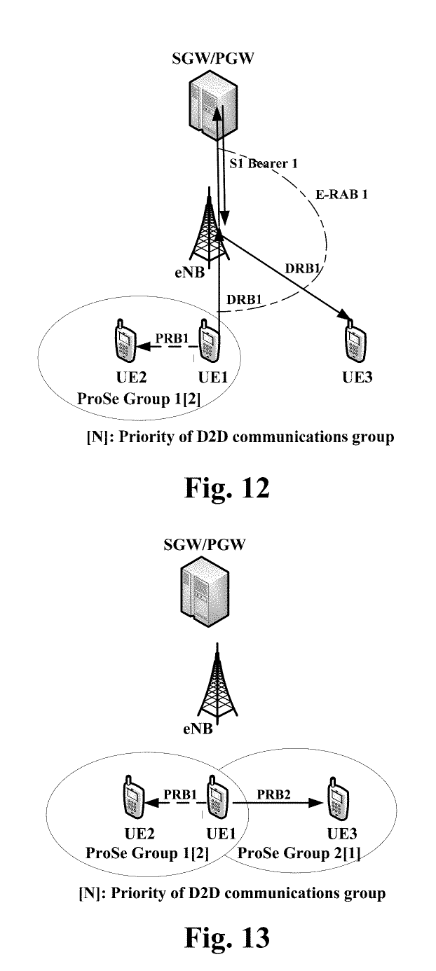

For example, FIG. 12 is a schematic diagram of a scenario before a communications mode of a traffic is converted of the embodiment of this disclosure, and FIG. 13 is a schematic diagram of a scenario after a communications mode of a traffic is converted of the embodiment of this disclosure. In the cases shown in FIGS. 12 and 13, UE 1 and UE 3 have an E-RAB 1 performing infrastructure communications, and at the same time, UE 1 and UE 2 have a PRB 1 performing D2D communications, and UE 1 and UE 2 belong to D2D communications group 1, i.e., ProSe Group 1. After the communications mode of the radio access bearer E-RAB 1 between UE 1 and UE 3 is converted from the infrastructure mode to the D2D communications mode, UE 1 and UE 3 form a new D2D communications group, i.e., ProSe Group 2.

After E-RAB 1 is converted into PRB 2 performing D2D communications, if there exist available to-be-transmitted data in a PDCP entity or an RLC entity to which PRB 2 corresponds and PRB 2 is a first radio bearer communicating based on the D2D communications mode in the D2D communications group, i.e., ProSe Group 2, formed by UE 1 and UE 3, what is different from Embodiment 3 is that whether there exist available to-be-transmitted data in the data buffer of the PDCP entity or the data buffer of the RLC entity to which PRB 1 in ProSe Group 1 corresponds needs to be further determined. If yes, whether the priority of ProSe Group 2 is higher than that of ProSe Group 1 is further determined. And if the priority of ProSe Group 2 is higher than that of ProSe Group 1, UE 1 triggers the ProSe-BSR.

Hence, the ProSe-BSR may be triggered or timely triggered, and the base station side may obtain or timely obtain data amounts of the D2D communications.

### Embodiment 5

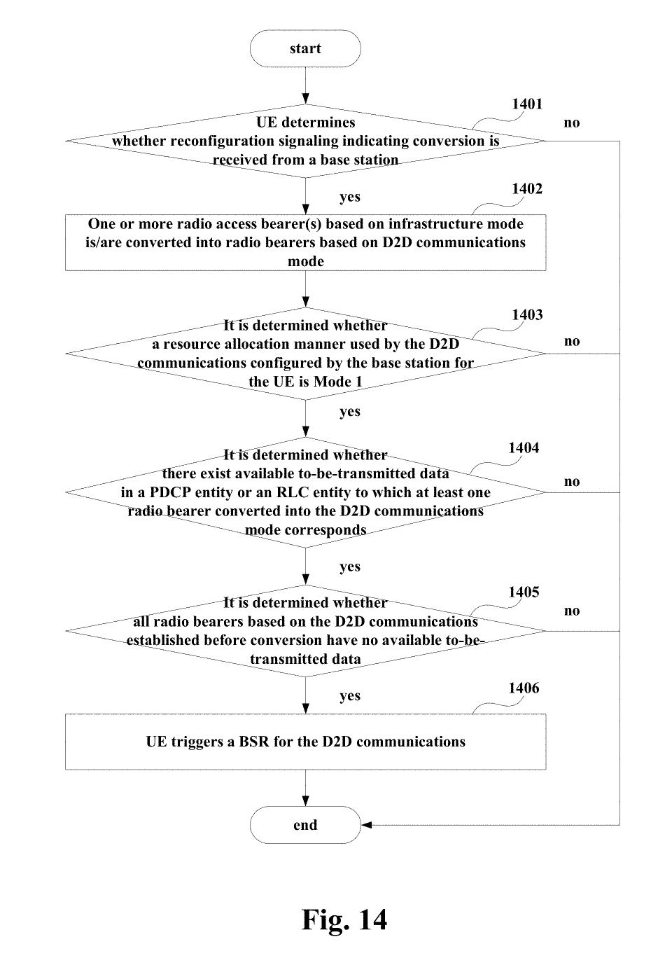

On the basis of Embodiment 1, an embodiment of this disclosure provides a method for triggering a buffer status report. FIG. 14 is a flowchart of the method for triggering a buffer status report of the embodiment of this disclosure. As shown in FIG. 14, the method includes:

step 1401: the UE determines whether reconfiguration signaling for indicating conversion is received from the base station, the reconfiguration signaling indicating the UE to convert one or more radio access bearer(s) based on the infrastructure mode into radio bearers based on the D2D communications mode, and step 1402 is executed if it is determined that the reconfiguration signaling is received;

step 1402: the one or more radio access bearer(s) based on the infrastructure mode is(are) converted into radio bearers based on the D2D communications mode;

step 1403: it is determined whether a resource allocation manner used by the D2D communications configured by the base station for the UE is a resource allocation manner based on scheduling of the base station, i.e., mode 1, and step 1404 is executed if a result of the above determination is yes;

step 1404: it is determined whether there exist available to-be-transmitted data in a PDCP entity or an RLC entity to which at least one radio bearer converted into the D2D communications mode corresponds, and step 1405 is executed if there exist available to-be-transmitted data;

step 1405: it is determined whether all radio bearers based on the D2D communications established by the UE before conversion have no available to-be-transmitted data, and step 1406 is executed if yes; and

step 1406: the UE triggers a B SR for the D2D communications.

In this embodiment, in a case where one or more radio access bearer(s) based on the infrastructure mode of the UE are converted into the radio bearers based on the D2D communications mode, if either one of the following conditions:

(1) there exist available to-be-transmitted data in a PDCP entity or an RLC entity to which at least one radio bearer converted into the D2D communications mode corresponds, and

(5) before conversion, all radio bearers based on the D2D communications established by the UE have no available to-be-transmitted data,

is not satisfied, the processing of this disclosure may be terminated. If both the above conditions (1) and (5) are satisfied, the UE triggers a BSR for the D2D communications, i.e., the ProSe-BSR, which is referred to as a regular BSR. And in a case where the UE has no uplink resource, the ProSe-BSR triggers transmission of a scheduling request.

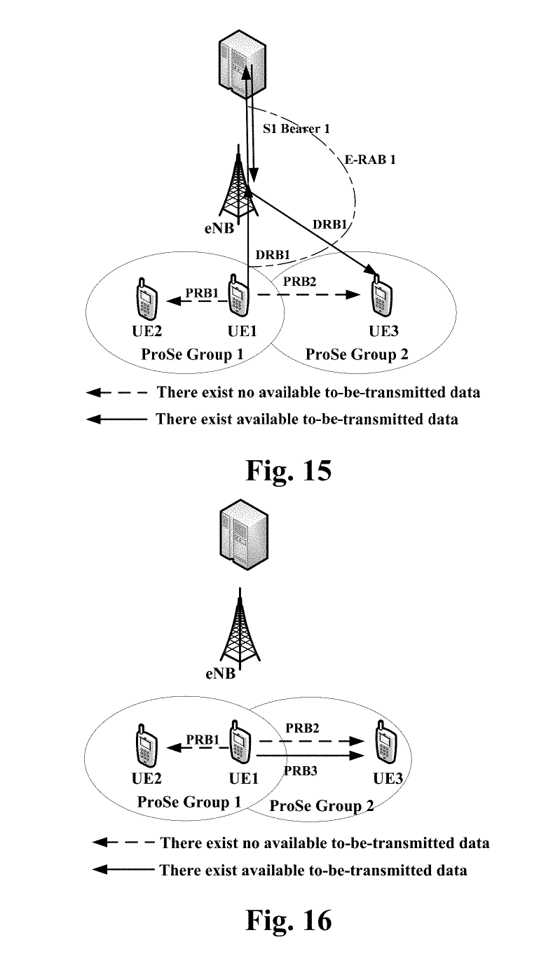

For example, FIG. 15 is a schematic diagram of a scenario before a communications mode of a traffic is converted of the embodiment of this disclosure, and FIG. 16 is a schematic diagram of a scenario after a communications mode of a traffic is converted of the embodiment of this disclosure. In the cases shown in FIGS. 15 and 16, UE 1 and UE 2 have PRB 1 performing D2D communications, and UE 1 and UE 2 belong to D2D communications group 1, i.e., ProSe Group 1. UE 1 and UE 3 have PRB 2 performing D2D communications, and UE 1 and UE 3 belong to D2D communications group 2, i.e., ProSe Group 2. And the radio access bearer E-RAB 1 performing infrastructure communications exists between UE 1 and UE 3.

After the communications mode of the radio access bearer E-RAB 1 between UE 1 and UE 3 is converted from the infrastructure mode to the D2D communications mode, if there exist no available to-be-transmitted data in PDCP entities and RLC entities to which the radio bearers PRB 1 and PRB 2 of a communications mode of the D2D communications mode established before by UE1 correspond and there exist available to-be-transmitted data in a PDCP entity or an RLC entity to which a newly-established radio bearer PRB 3 of a communications mode of the D2D communications mode corresponds, UE1 triggers the ProSe-BSR.

Hence, the ProSe-BSR may be triggered or timely triggered, and the base station side may obtain or timely obtain data amounts of the D2D communications.

### Embodiment 6

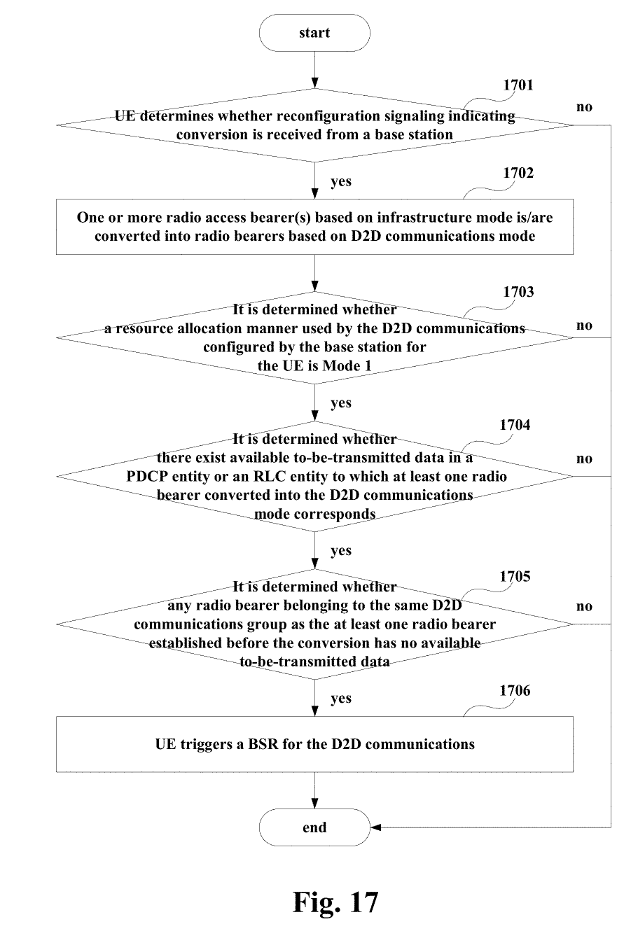

On the basis of Embodiment 1, an embodiment of this disclosure provides a method for triggering a buffer status report. FIG. 17 is a flowchart of the method for triggering a buffer status report of the embodiment of this disclosure. As shown in FIG. 17, the method includes:

step 1701: the UE determines whether reconfiguration signaling for indicating conversion is received from the base station, the reconfiguration signaling indicating the UE to convert one or more radio access bearer(s) based on the infrastructure mode into radio bearers based on the D2D communications mode, and step 1702 is executed if it is determined that the reconfiguration signaling is received;

step 1702: the one or more radio access bearer(s) based on the infrastructure mode is(are) converted into radio bearers based on the D2D communications mode;

step 1703: it is determined whether a resource allocation manner used by the D2D communications configured by the base station for the UE is a resource allocation manner based on scheduling of the base station, i.e., mode 1, and step 1704 is executed if a result of the above determination is yes;

step 1704: it is determined whether there exist available to-be-transmitted data in a PDCP entity or an RLC entity to which at least one radio bearer converted into the D2D communications mode corresponds, and step 1705 is executed if there exist available to-be-transmitted data;

step 1705: it is determined whether any radio bearer belonging to the same D2D communications group as the at least one radio bearer converted into the D2D communications mode established by the UE before the conversion has no available to-be-transmitted data, and step 1706 is executed if yes; and

step 1706: the UE triggers a B SR for the D2D communications.

In this embodiment, in a case where one or more radio access bearer(s) based on the infrastructure mode of the UE are converted into the radio bearers based on the D2D communications mode, if either one of the following conditions:

(1) there exist available to-be-transmitted data in a PDCP entity or an RLC entity to which at least one radio bearer converted into the D2D communications mode corresponds, and

(6) before the conversion, any radio bearer belonging to the same D2D communications group as the at least one radio bearer converted into the D2D communications mode established by the UE has no available to-be-transmitted data,

is not satisfied, the processing of this disclosure may be terminated. If both the above conditions (1) and (6) are satisfied, the UE triggers a BSR for the D2D communications, i.e., the ProSe-BSR, which is referred to as a regular BSR. And in a case where the UE has no uplink resource, the ProSe-BSR triggers transmission of a scheduling request.

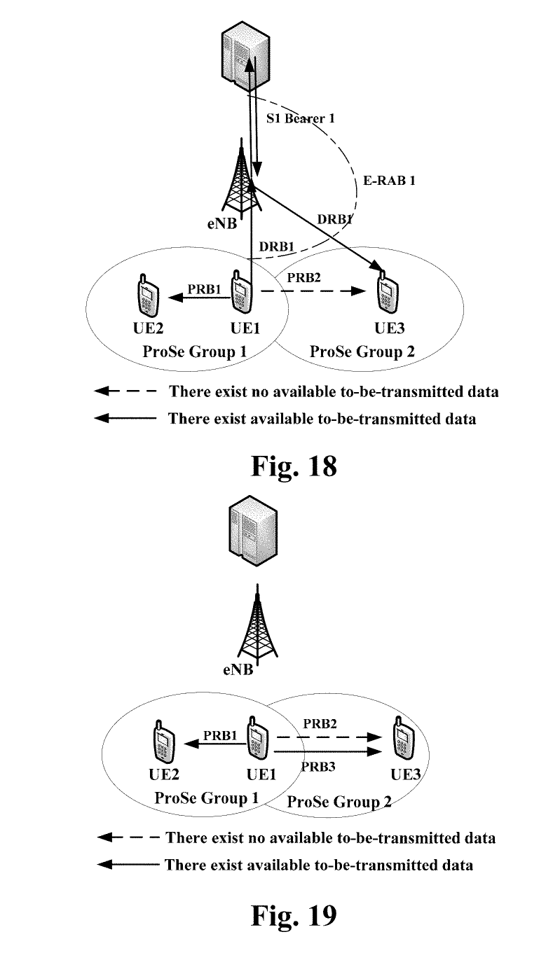

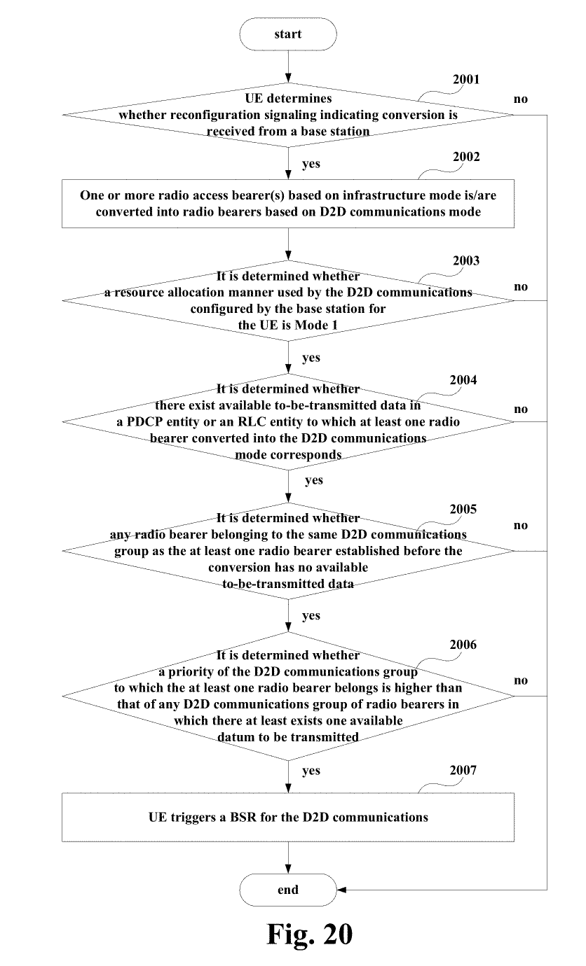

For example, FIG. 18 is a schematic diagram of a scenario before a communications mode of a traffic is converted of the embodiment of this disclosure, and FIG. 19 is a schematic diagram of a scenario after a communications mode of a traffic is converted of the embodiment of this disclosure. In the cases shown in FIGS. 18 and 19, similar to the cases shown in FIGS. 15 and 16, UE 1 and UE 2 have PRB 1 performing D2D communications, and UE 1 and UE 2 belong to D2D communications group 1, i.e., ProSe Group 1. UE 1 and UE 3 have PRB 2 performing D2D communications, and UE 1 and UE 3 belong to D2D communications group 2, i.e., ProSe Group 2. And the radio access bearer E-RAB 1 performing infrastructure communications exists between UE 1 and UE 3.

After the communications mode of the radio access bearer E-RAB 1 between UE 1 and UE 3 is converted from the infrastructure mode to the D2D communications mode, what is different from the case in Embodiment 5 is that no matter whether there exist available to-be-transmitted data in the PDCP entity and the RLC entity to which the radio bearer PRB 1 of a communications mode of the D2D communications mode established before in the D2D communications group formed by UE 1 and UE 2 corresponds, if only there exist no available to-be-transmitted data in the PDCP entity and the RLC entity to which the radio bearer PRB 2 of a communications mode of the D2D communications mode established before in the D2D communications group formed by UE 1 and UE 3 corresponds and there exist available to-be-transmitted data in the PDCP entity or the RLC entity to which the newly-established radio bearer PRB 3 of a communications mode of the D2D communications mode corresponds, UE 1 triggers the ProSe-BSR.

Hence, the ProSe-BSR may be triggered or timely triggered, and the base station side may obtain or timely obtain data amounts of the D2D communications.

### Embodiment 7

On the basis of Embodiment 1, an embodiment of this disclosure provides a method for triggering a buffer status report. FIG. 20 is a flowchart of the method for triggering a buffer status report of the embodiment of this disclosure. As shown in FIG. 20, the method includes:

step 2001: the UE determines whether reconfiguration signaling for indicating conversion is received from the base station, the reconfiguration signaling indicating the UE to convert one or more radio access bearer(s) based on the infrastructure mode into radio bearers based on the D2D communications mode, and step 2002 is executed if it is determined that the reconfiguration signaling is received;

step 2002: the one or more radio access bearer(s) based on the infrastructure mode is(are) converted into radio bearers based on the D2D communications mode;

step 2003: it is determined whether a resource allocation manner used by the D2D communications configured by the base station for the UE is a resource allocation manner based on scheduling of the base station, i.e., mode 1, and step 2004 is executed if a result of the above determination is yes;

step 2004: it is determined whether there exist available to-be-transmitted data in a PDCP entity or an RLC entity to which at least one radio bearer converted into the D2D communications mode corresponds, and step 2005 is executed if there exist available to-be-transmitted data;

step 2005: it is determined whether any radio bearer belonging to the same D2D communications group as the at least one radio bearer converted into the D2D communications mode established by the UE before the conversion has no available to-be-transmitted data, and step 2006 is executed if yes;

step 2006: it is determined whether a priority of the D2D communications group to which the at least one radio bearer based on the D2D communications mode belongs is higher than that of any D2D communications group of radio bearers based on the D2D communications mode in which there at least exists one available datum to be transmitted, and step 2007 is executed if yes; and

step 2007: the UE triggers a BSR for the D2D communications.

In this embodiment, in a case where one or more radio access bearer(s) based on the infrastructure mode of the UE are converted into the radio bearers based on the D2D communications mode, in addition to that the above conditions (1) and (6) are satisfied, the following condition should also be satisfied:

(7) the priority of the D2D communications group to which the at least one radio bearer based on the D2D communications mode belongs is higher than that of any D2D communications group of radio bearers based on the D2D communications mode in which there at least exists one available datum to be transmitted.

And the UE triggers the BSR for the D2D communications, i.e., the ProSe-BSR, which is referred to as a regular B SR. And in a case where the UE has no uplink resource, the ProSe-B SR triggers transmission of a scheduling request.

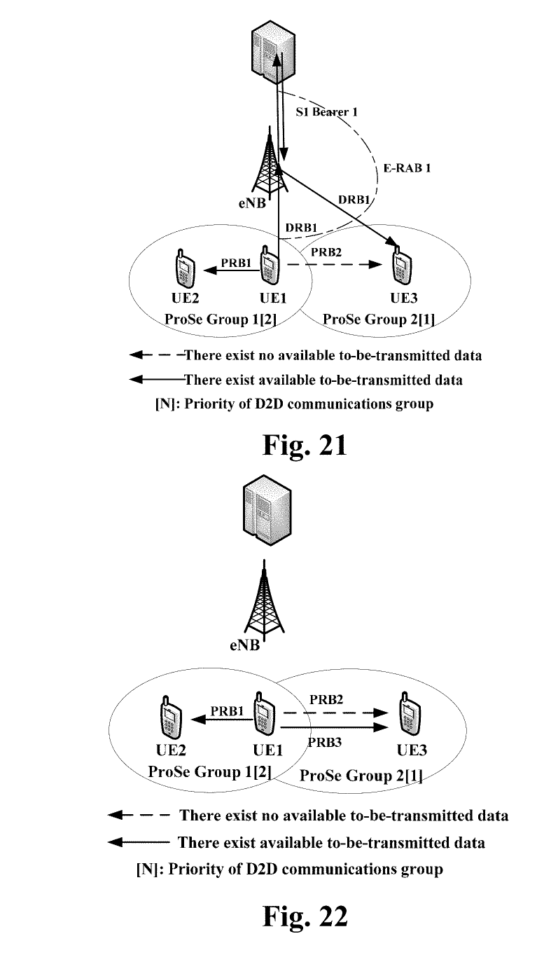

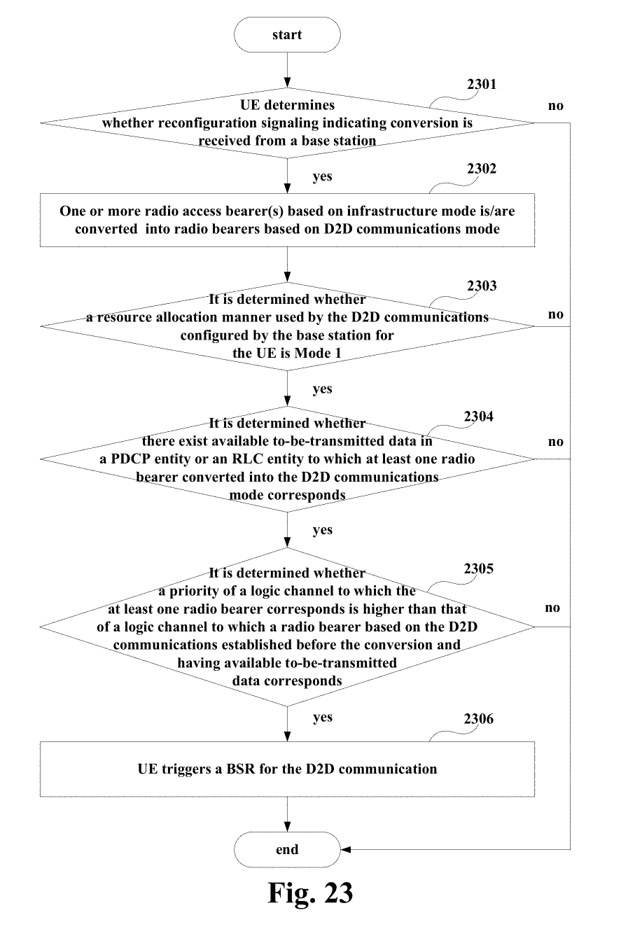

For example, FIG. 21 is a schematic diagram of a scenario before a communications mode of a traffic is converted of the embodiment of this disclosure, and FIG. 22 is a schematic diagram of a scenario after a communications mode of a traffic is converted of the embodiment of this disclosure. Taking the cases shown in FIGS. 21 and 22 as examples, UE 1 and UE 2 have a PRB 1 performing D2D communications, and UE 1 and UE 2 belong to D2D communications group 1, i.e., ProSe Group 1. And UE 1 and UE 3 have a PRB 2 performing D2D communications, and UE 1 and UE 3 belong to D2D communications group 2, i.e., ProSe Group 2. And the radio access bearer E-RAB 1 performing infrastructure communications exists between UE 1 and UE 3.

After the communications mode of the radio access bearer E-RAB 1 between UE 1 and UE 3 is converted from the infrastructure mode to the D2D communications mode, after the following conditions, 1) there exist no available to-be-transmitted data in the PDCP entity and RLC entity to which the radio bearer PRB 2 of a communications mode of the D2D communications mode established before in the D2D communications group formed by UE 1 and UE 3 corresponds, and 2) there exist available to-be-transmitted data in a PDCP entity or an RLC entity to which a newly-established radio bearer PRB 3 of a communications mode of the D2D communications mode corresponds, are satisfied, what is different from Embodiment 6 is that a condition 3) whether there exist available to-be-transmitted data in the data buffer of the PDCP entity or the data buffer of the RLC entity to which PRB 1 in ProSe Group 1 corresponds, needs to be further determined. If yes, a condition 4) whether the priority of ProSe Group 2 is higher than that of ProSe Group 1, needs to be further determined. And if the priority of ProSe Group 2 is higher than that of ProSe Group 1, UE 1 triggers the ProSe-BSR.

Hence, the ProSe-BSR may be triggered or timely triggered, and the base station side may obtain or timely obtain data amounts of the D2D communications.

### Embodiment 8

On the basis of Embodiment 1, an embodiment of this disclosure provides a method for triggering a buffer status report. FIG. 23 is a flowchart of the method for triggering a buffer status report of the embodiment of this disclosure. As shown in FIG. 23, the method includes:

step 2301: the UE determines whether reconfiguration signaling for indicating conversion is received from the base station, the reconfiguration signaling indicating the UE to convert one or more radio access bearer(s) based on the infrastructure mode into radio bearers based on the D2D communications mode, and step 2302 is executed if it is determined that the reconfiguration signaling is received;

step 2302: the one or more radio access bearer(s) based on the infrastructure mode is(are) converted into radio bearers based on the D2D communications mode;

step 2303: it is determined whether a resource allocation manner used by the D2D communications configured by the base station for the UE is a resource allocation manner based on scheduling of the base station, i.e., mode 1, and step 2304 is executed if a result of the above determination is yes;

step 2304: it is determined whether there exist available to-be-transmitted data in a PDCP entity or an RLC entity to which at least one radio bearer converted into the D2D communications mode corresponds, and step 2305 is executed if there exist available to-be-transmitted data;

step 2305: it is determined whether a priority of a logic channel to which the at least one radio bearer converted into the D2D communications mode corresponds is higher than that of a logic channel to which a radio bearer based on the D2D communications established by the UE before the conversion and having available to-be-transmitted data corresponds, and step 2306 is executed if yes; and

step 2306: the UE triggers a BSR for the D2D communications.

In this embodiment, in a case where one or more radio access bearer(s) based on the infrastructure mode of the UE are converted into the radio bearers based on the D2D communications mode, if either one of the following conditions:

(1) there exist available to-be-transmitted data in a PDCP entity or an RLC entity to which at least one radio bearer converted into the D2D communications mode corresponds, and

(8) the priority of the logic channel to which the at least one radio bearer converted into the D2D communications mode corresponds is higher than that of the logic channel to which a radio bearer based on the D2D communications established by the UE before the conversion and having available to-be-transmitted data corresponds,

is not satisfied, the processing of this disclosure may be terminated. If both the above conditions (1) and (8) are satisfied, the UE triggers a BSR for the D2D communications, i.e., the ProSe-BSR, which is referred to as a regular BSR. And in a case where the UE has no uplink resource, the ProSe-BSR triggers transmission of a scheduling request.

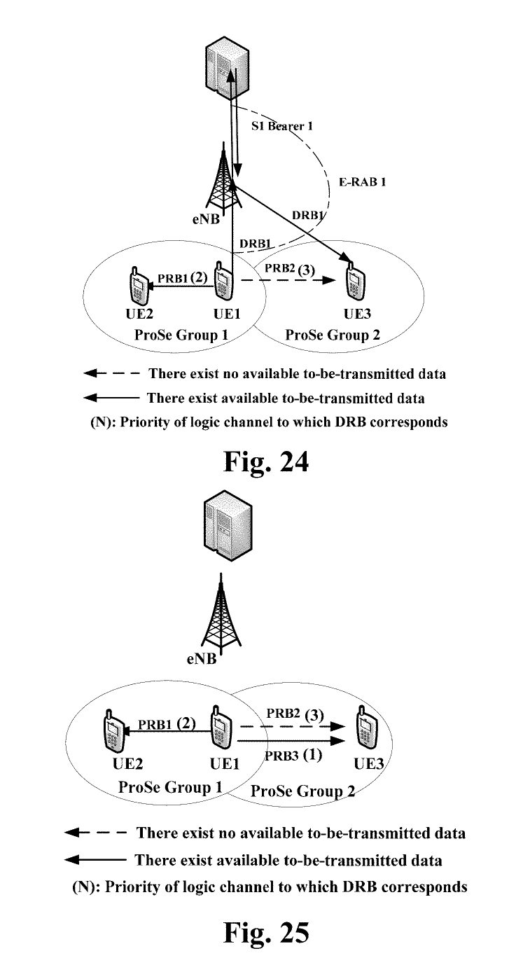

For example, FIG. 24 is a schematic diagram of a scenario before a communications mode of a traffic is converted of the embodiment of this disclosure, and FIG. 25 is a schematic diagram of a scenario after a communications mode of a traffic is converted of the embodiment of this disclosure. In the cases shown in FIGS. 24 and 25, UE 1 and UE 2 have PRB 1 performing D2D communications, and UE 1 and UE 2 belong to D2D communications group 1, i.e., ProSe Group 1. UE 1 and UE 3 have PRB 2 performing D2D communications, and UE 1 and UE 3 belong to D2D communications group 2, i.e., ProSe Group 2. And the radio access bearer E-RAB 1 performing infrastructure communications exists between UE 1 and UE 3.

After the communications mode of the radio access bearer E-RAB 1 between UE 1 and UE 3 is converted from the infrastructure mode to the D2D communications mode, after determining that there exist available to-be-transmitted data in the PDCP entity or the RLC entity to which the newly-established radio bearer PRB 3 of a communications mode of the D2D communications mode corresponds, UE 1 needs further to determine whether there exist available to-be-transmitted data in the PDCP entities or the RLC entities to which the radio bearers PRB1 and PRB 2 of a communications mode of the D2D communications mode established before correspond. If there exist available to-be-transmitted data in the PDCP entity or the RLC entity to which PRB 1 corresponds, but there exist no available to-be-transmitted data in the PDCP entity or the RLC entity to which PRB 2 corresponds, UE 1 needs further to determine a relationship between the priority of the logic channel to which PRB 1 corresponds and the priority of the logic channel to which PRB 3 corresponds. And if the priority of the logic channel to which PRB 3 corresponds is higher than the priority of the logic channel to which PRB 1 corresponds, UE 1 triggers the ProSe-BSR.

Hence, the ProSe-BSR may be triggered or timely triggered, and the base station side may obtain or timely obtain data amounts of the D2D communications.

### Embodiment 9

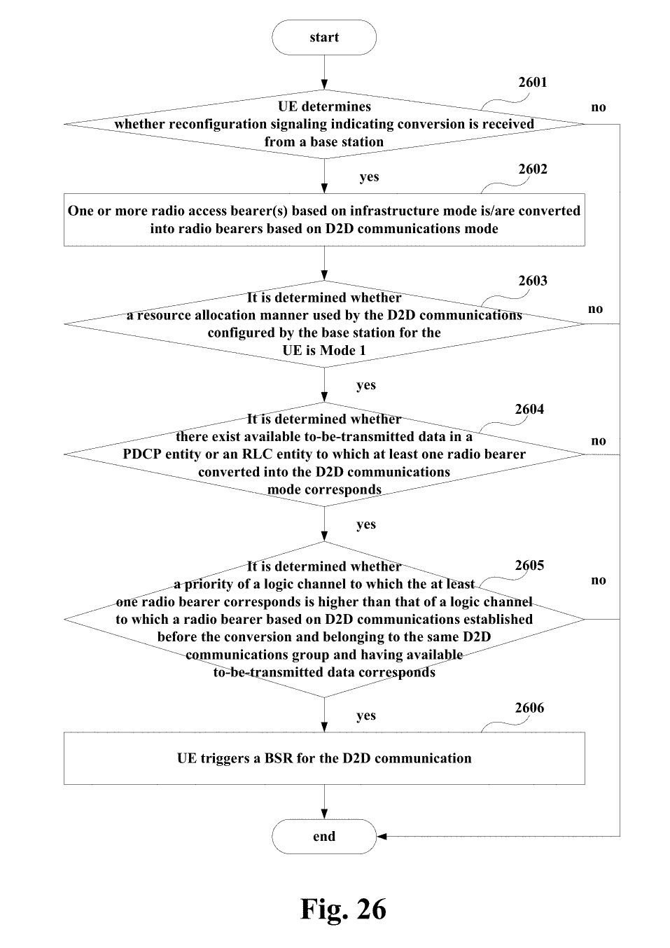

On the basis of Embodiment 1, an embodiment of this disclosure provides a method for triggering a buffer status report. FIG. 26 is a flowchart of the method for triggering a buffer status report of the embodiment of this disclosure. As shown in FIG. 26, the method includes:

step 2601: the UE determines whether reconfiguration signaling for indicating conversion is received from the base station, the reconfiguration signaling indicating the UE to convert one or more radio access bearer(s) based on the infrastructure mode into radio bearers based on the D2D communications mode, and step 2602 is executed if it is determined that the reconfiguration signaling is received;

step 2602: the one or more radio access bearer(s) based on the infrastructure mode is(are) converted into radio bearers based on the D2D communications mode;

step 2603: it is determined whether a resource allocation manner used by the D2D communications configured by the base station for the UE is a resource allocation manner based on scheduling of the base station, i.e., mode 1, and step 2604 is executed if a result of the above determination is yes;

step 2604: it is determined whether there exist available to-be-transmitted data in a PDCP entity or an RLC entity to which at least one radio bearer converted into the D2D communications mode corresponds, and step 2605 is executed if there exist available to-be-transmitted data;

step 2605: it is determined whether a priority of a logic channel to which the at least one radio bearer converted into the D2D communications mode corresponds is higher than that of a logic channel to which a radio bearer based on the D2D communications established by the UE before the conversion and belonging to the same D2D communications group as the at least one radio bearer and having available to-be-transmitted data corresponds, and step 2606 is executed if yes; and

step 2606: the UE triggers a B SR for the D2D communications.

In this embodiment, in a case where one or more radio access bearer(s) based on the infrastructure mode of the UE are converted into the radio bearers based on the D2D communications mode, if either one of the following conditions:

(1) there exist available to-be-transmitted data in a PDCP entity or an RLC entity to which at least one radio bearer converted into the D2D communications mode corresponds, and

(9) the priority of a logic channel to which the at least one radio bearer converted into the D2D communications mode corresponds is higher than that of a logic channel to which a radio bearer based on the D2D communications established by the UE before the conversion and belonging to the same D2D communications group as the at least one radio bearer and having available to-be-transmitted data corresponds,

is not satisfied, the processing of this disclosure may be terminated. If both the above conditions (1) and (9) are satisfied, the UE triggers a BSR for the D2D communications, i.e., the ProSe-BSR, which is referred to as a regular BSR. And in a case where the UE has no uplink resource, the ProSe-BSR triggers transmission of a scheduling request.

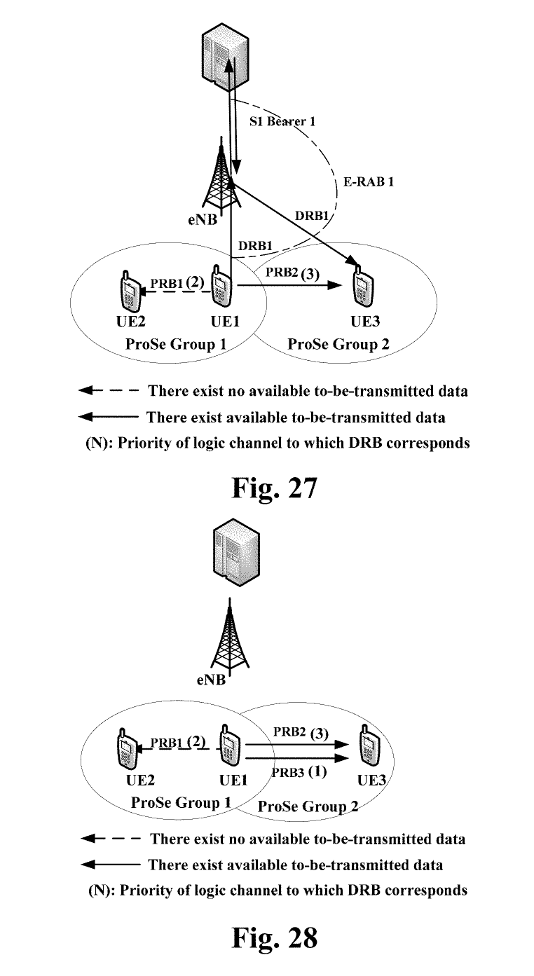

For example, FIG. 27 is a schematic diagram of a scenario before a communications mode of a traffic is converted of the embodiment of this disclosure, and FIG. 28 is a schematic diagram of a scenario after a communications mode of a traffic is converted of the embodiment of this disclosure. In the cases shown in FIGS. 27 and 28, UE 1 and UE 2 have PRB 1 performing D2D communications, and UE 1 and UE 2 belong to D2D communications group 1, i.e., ProSe Group 1. UE 1 and UE 3 have PRB 2 performing D2D communications, and UE 1 and UE 3 belong to D2D communications group 2, i.e., ProSe Group 2. And the radio access bearer E-RAB 1 performing infrastructure communications exists between UE 1 and UE 3.

After the communications mode of the radio access bearer E-RAB 1 between UE 1 and UE 3 is converted from the infrastructure mode to the D2D communications mode, and after determining that there exist available to-be-transmitted data in the PDCP entity or the RLC entity to which the newly-established radio bearer PRB 3 of a communications mode of the D2D communications mode corresponds, UE 1 needs further to determine whether there exist available to-be-transmitted data in the PDCP entity or the RLC entity to which the radio bearer PRB 2 of a communications mode of the D2D communications mode established before and belonging to the same D2D communications group corresponds.

If there exist available to-be-transmitted data in the PDCP entity or the RLC entity to which PRB 2 corresponds, UE 1 needs further to determine a relationship between the priority of the logic channel to which PRB 2 corresponds and the priority of the logic channel to which PRB 3 corresponds. And if the priority of the logic channel to which PRB 3 corresponds is higher than the priority of the logic channel to which PRB 2 corresponds, UE 1 triggers the ProSe-BSR.

In this embodiment, UE 1 needs not to judge whether there exist available to-be-transmitted data in the PDCP entity and the RLC entity to which the radio bearer PRB 1 in the D2D communications group between UE 1 and UE 2 corresponds.

Hence, the ProSe-BSR may be triggered or timely triggered, and the base station side may obtain or timely obtain data amounts of the D2D communications.

### Embodiment 10

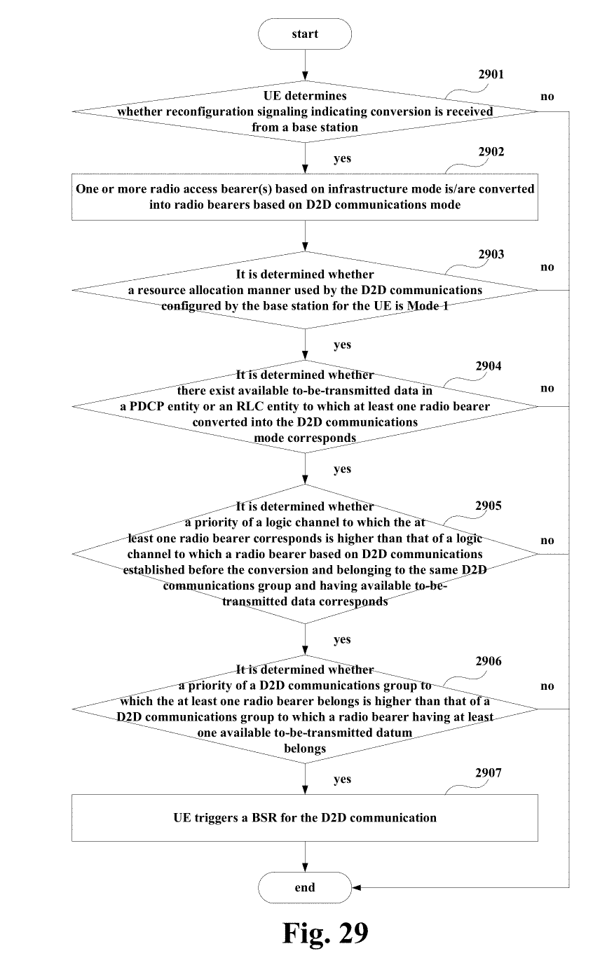

On the basis of Embodiment 1, an embodiment of this disclosure provides a method for triggering a buffer status report. FIG. 29 is a flowchart of the method for triggering a buffer status report of the embodiment of this disclosure. As shown in FIG. 29, the method includes:

step 2901: the UE determines whether reconfiguration signaling for indicating conversion is received from the base station, the reconfiguration signaling indicating the UE to convert one or more radio access bearer(s) based on the infrastructure mode into radio bearers based on the D2D communications mode, and step 2902 is executed if it is determined that the reconfiguration signaling is received;

step 2902: the one or more radio access bearer(s) based on the infrastructure mode is(are) converted into radio bearers based on the D2D communications mode;

step 2903: it is determined whether a resource allocation manner used by the D2D communications configured by the base station for the UE is a resource allocation manner based on scheduling of the base station, i.e., mode 1, and step 2904 is executed if a result of the above determination is yes;

step 2904: it is determined whether there exist available to-be-transmitted data in a PDCP entity or an RLC entity to which at least one radio bearer converted into the D2D communications mode corresponds, and step 2905 is executed if there exist available to-be-transmitted data;

step 2905: it is determined whether a priority of a logic channel to which the at least one radio bearer converted into the D2D communications mode corresponds is higher than that of a logic channel to which a radio bearer based on the D2D communications established by the UE before the conversion and belonging to the same D2D communications group as the at least one radio bearer and having available to-be-transmitted data corresponds, and step 2906 is executed if yes;

step 2906: it is determined whether a priority of a D2D communications group to which the at least one radio bearer converted into the D2D communications mode belongs is higher than that of a D2D communications group to which a radio bearer having at least one available to-be-transmitted datum belongs, and step 2907 is executed if yes; and

step 2907: the UE triggers a BSR for the D2D communications.

In this embodiment, in a case where one or more radio access bearer(s) based on the infrastructure mode of the UE are converted into the radio bearers based on the D2D communications mode, in addition to that the above conditions (1) and (9) are satisfied, the following condition should also be satisfied:

(10) the priority of a D2D communications group to which the at least one radio bearer converted into the D2D communications mode belongs is higher than that of a D2D communications group to which a radio bearer having at least one available to-be-transmitted datum belongs.

And the UE triggers the BSR for the D2D communications, i.e., the ProSe-BSR, which is referred to as a regular B SR. And in a case where the UE has no uplink resource, the ProSe-B SR triggers transmission of a scheduling request.

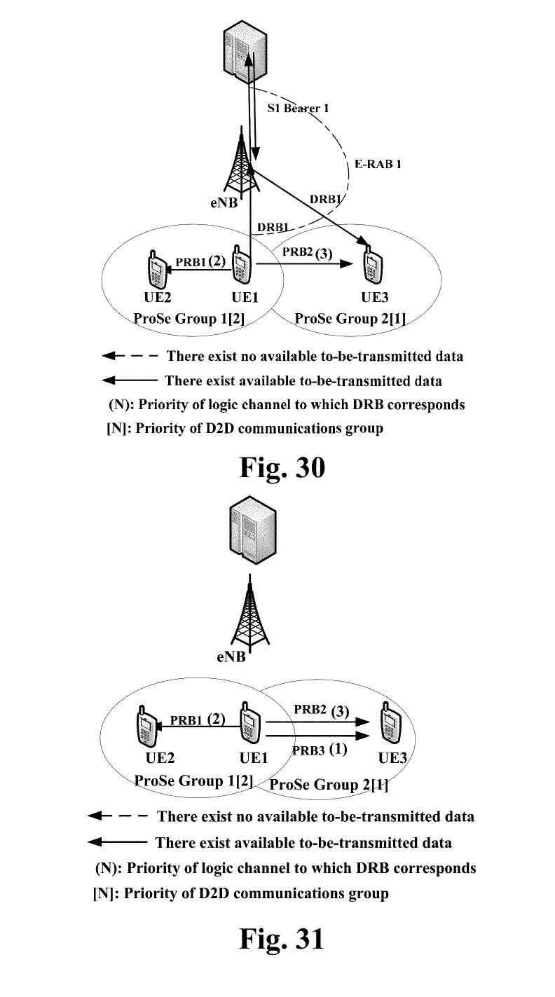

For example, FIG. 30 is a schematic diagram of a scenario before a communications mode of a traffic is converted of the embodiment of this disclosure, and FIG. 31 is a schematic diagram of a scenario after a communications mode of a traffic is converted of the embodiment of this disclosure. In the cases shown in FIGS. 30 and 31, UE 1 and UE 2 have a PRB 1 performing D2D communications, and UE 1 and UE 2 belong to D2D communications group 1, i.e., ProSe Group 1. And UE 1 and UE 3 have a PRB 2 performing D2D communications, and UE 1 and UE 3 belong to D2D communications group 2, i.e., ProSe Group 2. And the radio access bearer E-RAB 1 performing infrastructure communications exists between UE 1 and UE 3.

After the communications mode of the radio access bearer E-RAB 1 between UE 1 and UE 3 is converted from the infrastructure mode to the D2D communications mode, after determining that there exist available to-be-transmitted data in a PDCP entity or an RLC entity to which the newly-established radio bearer PRB 3 of a communications mode of the D2D communications mode corresponds, UE 1 needs further to determine whether there exist available to-be-transmitted data in the PDCP entity or the RLC entity to which the radio bearer PRB 2 of a communications mode of the D2D communications established before and belonging to the same D2D communications group as PRB 3 corresponds.

If there exist available to-be-transmitted data in the PDCP entity or the RLC entity to which PRB 2 corresponds, UE 1 needs further to determine a relationship between the priority of the logic channel to which PRB 2 corresponds and the priority of the logic channel to which PRB 3 corresponds. And if the priority of the logic channel to which PRB 3 corresponds is higher than the priority of the logic channel to which PRB 2 corresponds, UE 1 needs further to determine whether there exist available to-be-transmitted data in the data buffer of the PDCP entity or the data buffer of the RLC entity to which PRB 1 in ProSe Group 1 corresponds.

If yes, whether the priority of the D2D communications group ProSe Group 2 to which PRB 2 belongs is higher than that of the D2D communications group ProSe Group 1 to which PRB 1 belongs is further determined. And it the priority of ProSe Group 2 is high than that of ProSe Group 1, UE 1 triggers the ProSe-BSR.

Hence, the ProSe-BSR may be triggered or timely triggered, and the base station side may obtain or timely obtain data amounts of the D2D communications.

### Embodiment 11

An embodiment of this disclosure provides a method for triggering a buffer status report, applicable to a case where one or more radio bearer(s) of UE based on a D2D communications mode is/are converted into radio access bearers based on an infrastructure mode.

In this embodiment, for example, following scenarios are taken into account: UE 1 is communicating with UE 2 for two traffics (such a voice traffic and a data traffic) by using the D2D communications mode. The two traffics have respective specific radio bearer configuration of D2D communications (including a DCP entity, an RLC entity and a logic channel), and the logic channels to which the two traffics correspond belong to the same logic channel group. During communications, when a triggering condition of a ProSe-BSR is satisfied, the UE will report the ProSe-BSR.

At a certain moment, after the D2D communications satisfies a condition, one of the traffics (such as the data traffic) needs to be converted into the D2D communications. The condition may be, for example, that UE 1 and UE 2 discover via a D2D discovery mechanism that an application to which the traffic corresponds does not support the D2D communications. Thereafter, the communications mode of the data traffic between UE 1 and UE 2 is converted into EPC communications, and the voice traffic continues to adopt theD2D communications.

After the mode conversion, a base station may immediately acquire a size of a data amount of the data traffic, since a regular BSR will be triggered after the conversion is completed. However, the base station is unable to immediately acquire an accurate data amount of the voice traffic stilling adopting the D2D communications.

Of course, after a reretxBSR-timer to which the ProSe-BSR corresponds expires or a periodicBSR-timer expires, the UE will trigger the ProSe-BSR; however, this will bring latency to scheduling of the base station, affect QoS (Quality of Service) of the traffics, and be unable to satisfy a requirement of guaranteeing continuity of services during the mode conversion.

Hence, the base station is unable to obtain or unable to timely obtain such information as a data amount in the D2D communications mode, etc.

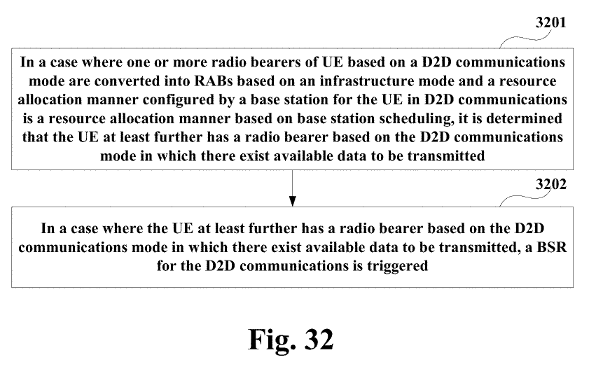

FIG. 32 is a flowchart of the method for triggering a buffer status report of the embodiment of this disclosure. As shown in FIG. 32, the method includes:

step 3201: in a case where one or more radio bearer(s) of the user equipment based on a D2D communications mode are converted into radio access bearers based on an infrastructure mode and a resource allocation manner configured by a base station for the user equipment in D2D communications is a resource allocation manner based on base station scheduling, it is determined that the user equipment at least further has a radio bearer based on the D2D communications mode in which there exist available data to be transmitted; and

step 3202: in a case where the user equipment at least further has a radio bearer based on the D2D communications mode in which there exist available data to be transmitted, a BSR for the D2D communications is triggered.

In this embodiment, if the UE has at least one radio bearer which is converted from the D2D communications mode into the infrastructure mode and the UE further has a radio bearer based on the D2D communications mode in which there exist available data to be transmitted, the UE triggers a BSR for the D2D communications, i.e., the ProSe-BSR, which is referred to as a regular BSR. And in a case where the UE has no uplink resource, the ProSe-BSR triggers transmission of a scheduling request.

Hence, the ProSe-BSR may be triggered or timely triggered, and the base station side may obtain or timely obtain data amounts of the D2D communications.

### Embodiment 12

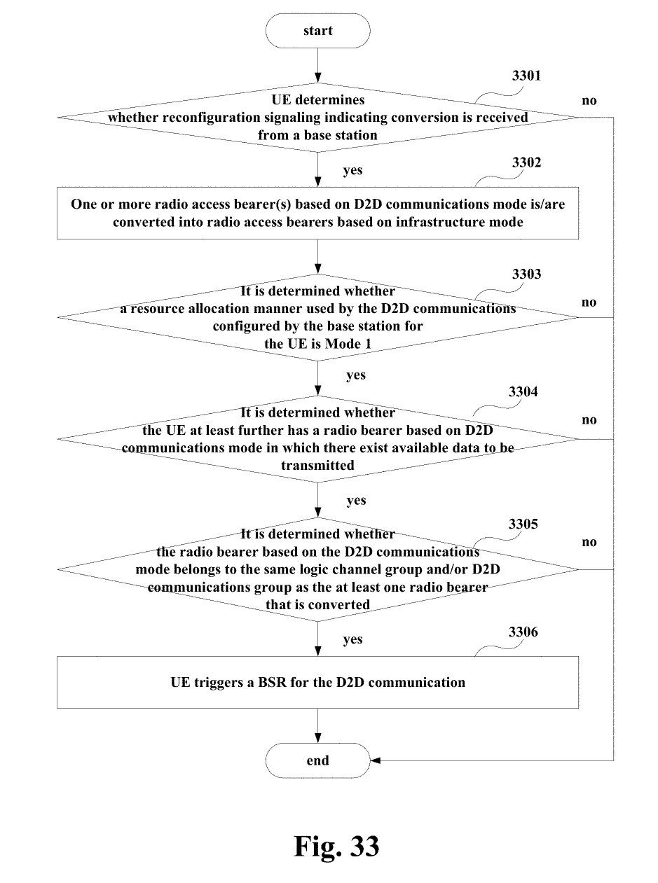

On the basis of Embodiment 11, an embodiment of this disclosure provides a method for triggering a buffer status report. FIG. 33 is a flowchart of the method for triggering a buffer status report of the embodiment of this disclosure. As shown in FIG. 33, the method includes:

step 3301: the UE determines whether reconfiguration signaling for indicating conversion is received from the base station, the reconfiguration signaling indicating the UE to convert one or more radio bearer(s) based on the D2D communications mode into radio access bearers based on the infrastructure mode, and step3302 is executed if it is determined that the reconfiguration signaling is received;

step 3302: the one or more radio access bearer(s) based on D2D communications mode is(are) converted into radio access bearers based on the infrastructure mode;

step 3303: it is determined whether a resource allocation manner used by the D2D communications configured by the base station for the UE is a resource allocation manner based on scheduling of the base station, i.e., mode 1, and step 3304 is executed if a result of the above determination is yes;

step 3304: it is determined whether the user equipment at least further has a radio bearer based on the D2D communications mode in which there exist available data to be transmitted, and step 3305 is executed if yes;

step 3305: it is determined whether the radio bearer based on the D2D communications mode belongs to the same logic channel group and/or D2D communications group as the at least one radio bearer that is converted, and step 3306 is executed if yes; and

step 3306: the UE triggers a BSR for the D2D communications.

For example, UE 1 has a PRB 1 performing D2D communications. After PRB 1 is converted into an E-RAB 1 performing infrastructure communications, if UE 1 further has a PRB 2 performing D2D communications and PRB 2 belongs to the same logic channel group as PRB 1 (or PRB 2 belongs to the same D2D communications group as PRB 1), UE 1 triggers the ProSe-BSR.

Hence, the ProSe-BSR may be triggered or timely triggered, and the base station side may obtain or timely obtain data amounts of the D2D communications.

### Embodiment 13

An embodiment of this disclosure provides an apparatus for triggering a buffer status report (BSR), configured in user equipment. This embodiment corresponds to embodiments 1-10, with identical contents being not going to be described herein any further.

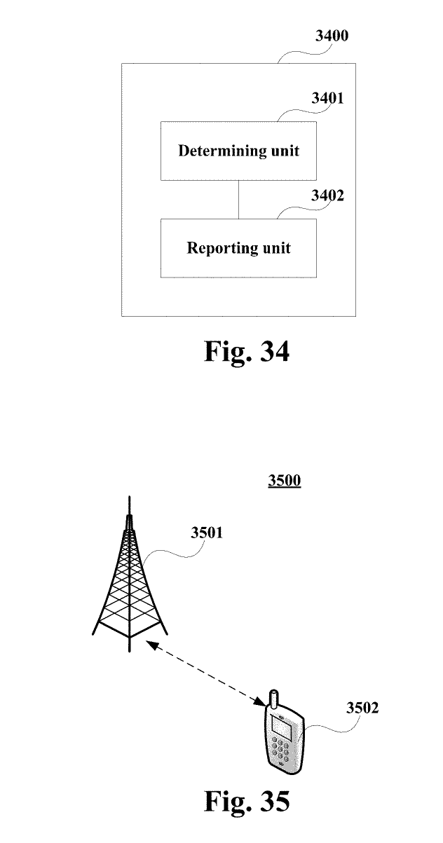

FIG. 34 is a schematic diagram of a structure of the apparatus for triggering a buffer status report of the embodiment of this disclosure. As shown in FIG. 34, the apparatus 3400 for triggering a buffer status report includes: a determining unit 3401 and a reporting unit 3402;

the determining unit 3401 is configured to, in a case where one or more radio access bearer(s) of the user equipment based on an infrastructure mode are converted into radio bears based on a device to device (D2D) communications mode and a resource allocation manner configured by a base station for the user equipment in D2D communications is a resource allocation manner based on base station scheduling, determine that there exist available data to be transmitted in a packet data convergence protocol (PDCP) entity or a radio link control (RLC) entity to which at least one radio bearer in the one or more radio bearer(s) based on the D2D communications mode corresponds;

and the reporting unit 3402 is configured to, in a case where there exist available data to be transmitted in the PDCP entity or the RLC entity to which the at least one radio bearer based on the D2D communications mode corresponds, trigger a BSR for the D2D communications.

In an implementation, the determining unit 3401 is further configured to determine that the user equipment does not establish any radio bearer based on the D2D communications mode before the one or more radio access bearer(s) based on the infrastructure mode are converted into radio bears based on the D2D communications mode;

and the reporting unit 3402 is further configured to, in a case where there exist available data to be transmitted in the PDCP entity or the RLC entity to which the at least one radio bearer based on the D2D communications mode corresponds and the user equipment does not establish any radio bearer based on the D2D communications mode before the conversion, trigger the BSR for the D2D communications.

In another implementation, the determining unit 3401 is further configured to determine that the user equipment does not establish any radio bearer belonging to the same D2D communications group as the at least one radio bearer based on the D2D communications mode before the one or more radio access bearer(s) based on the infrastructure mode are converted into radio bears based on the D2D communications mode;

and the reporting 3402 unit is further configured to, in a case where there exist available data to be transmitted in the PDCP entity or the RLC entity to which the at least one radio bearer based on the D2D communications mode corresponds and the user equipment does not establish any radio bearer belonging to the same D2D communications group as the at least one radio bearer based on the D2D communications mode before the conversion, trigger the BSR for the D2D communications.

In a further implementation, the determining unit 3401 is further configured to determine that a priority of the D2D communications group to which the at least one radio bearer based on the D2D communications mode belongs is higher than that of any D2D communications group of radio bearers based on the D2D communications mode in which there at least exists one available datum to be transmitted;

and the reporting unit 3402 is further configured to, in a case where there exist available data to be transmitted in the PDCP entity or the RLC entity to which the at least one radio bearer based on the D2D communications mode corresponds, the user equipment does not establish any radio bearer belonging to the same D2D communications group as the at least one radio bearer based on the D2D communications mode before the conversion, and the priority of the D2D communications group to which the at least one radio bearer based on the D2D communications mode belongs is higher than that of any D2D communications group of radio bearers based on the D2D communications mode in which there at least exists one available datum to be transmitted, trigger the BSR for the D2D communications.

In still another implementation, the determining unit 3401 is further configured to determine that before the one or more radio access bearer(s) of the user equipment based on an infrastructure mode are converted into radio bears based on a D2D communications mode, there exists no available data to be transmitted in any radio bearer based on the D2D communications mode established by the user equipment;

and the reporting unit 3402 is further configured to, in a case where there exist available data to be transmitted in the PDCP entity or the RLC entity to which the at least one radio bearer based on the D2D communications mode corresponds and there exists no available data to be transmitted in any radio bearer based on the D2D communications mode established by the user equipment before the conversion, trigger the BSR for the D2D communications.

In still another implementation, the determining unit 3401 is further configured to determine that before the one or more radio access bearer(s) of the user equipment based on an infrastructure mode are converted into radio bears based on a D2D communications mode, there exists no available data to be transmitted in any radio bearer belonging to the same D2D communications group as the at least one radio bearer based on the D2D communications mode established by the user equipment;

and the reporting unit 3402 is further configured to, in a case where there exists an available datum to be transmitted in the PDCP entity or the RLC entity to which the at least one radio bearer based on the D2D communications mode corresponds and there exists no available data to be transmitted in any radio bearer belonging to the same D2D communications group as the at least one radio bearer based on the D2D communications mode established by the user equipment before the conversion, trigger the BSR for the D2D communications.

In still another implementation, the determining unit 3401 is further configured to determine that a priority of the D2D communications group to which the at least one radio bearer based on the D2D communications mode belongs is higher than that of any D2D communications group of radio bearers based on the D2D communications mode in which there at least exists one available datum to be transmitted;

and the reporting unit 3402 is further configured to, in a case where there exists an available datum to be transmitted in the PDCP entity or the RLC entity to which the at least one radio bearer based on the D2D communications mode corresponds, there exists no available data to be transmitted in any radio bearer belonging to the same D2D communications group as the at least one radio bearer based on the D2D communications mode established by the user equipment before the conversion, and the priority of the D2D communications group to which the at least one radio bearer based on the D2D communications mode belongs is higher than that of any D2D communications group of radio bearers based on the D2D communications mode in which there at least exists one available datum to be transmitted, trigger the BSR for the D2D communications.

In still another implementation, the determining unit 3401 is further configured to determine that a priority of a logic channel to which the at least one radio bearer based on the D2D communications mode corresponds is higher than that of a logic channel to which any radio bearer based on the D2D communications mode established by the user equipment before the conversion in which there exists available data to be transmitted corresponds;

and the reporting unit 3402 is further configured to, in a case where there exist available data to be transmitted in the PDCP entity or the RLC entity to which the at least one radio bearer based on the D2D communications mode corresponds and the priority of the logic channel to which the at least one radio bearer based on the D2D communications mode corresponds is higher than that of the logic channel to which any radio bearer based on the D2D communications mode established by the user equipment before the conversion in which there exist available data to be transmitted corresponds, trigger the BSR for the D2D communications.

In still another implementation, the determining unit 3401 is further configured to determine that a priority of a logic channel to which the at least one radio bearer based on the D2D communications mode corresponds is higher than that of a logic channel to which a radio bearer based on the D2D communications mode established by the user equipment before the conversion and belonging to the same D2D communications group as the at least one radio bearer based on the D2D communications mode and in which there exist available data to be transmitted corresponds;

and the reporting unit 3402 is further configured to, in a case where there exist available data to be transmitted in the PDCP entity or the RLC entity to which the at least one radio bearer based on the D2D communications mode corresponds and the priority of a logic channel to which the at least one radio bearer based on the D2D communications mode corresponds is higher than that of a logic channel to which a radio bearer based on the D2D communications mode established by the user equipment before the conversion and belonging to the same D2D communications group as the at least one radio bearer based on the D2D communications mode and in which there exist available data to be transmitted corresponds, trigger the BSR for the D2D communications.

In still another implementation, the determining unit 3401 is further configured to determine that a priority of the D2D communications group to which the at least one radio bearer based on the D2D communications mode belongs is higher than that of any D2D communications group of radio bearers based on the D2D communications mode in which there at least exists one available datum to be transmitted;

and the reporting unit 3402 is further configured to, in a case where there exist available data to be transmitted in the PDCP entity or the RLC entity to which the at least one radio bearer based on the D2D communications mode corresponds, the priority of the logic channel to which the at least one radio bearer based on the D2D communications mode corresponds is higher than that of the logic channel to which the radio bearer based on the D2D communications mode established by the user equipment before the conversion and belonging to the same D2D communications group as the at least one radio bearer based on the D2D communications mode and in which there exist available data to be transmitted corresponds, and the priority of the D2D communications group to which the at least one radio bearer based on the D2D communications mode belongs is higher than that of any D2D communications group of radio bearers based on the D2D communications mode in which there at least exists one available datum to be transmitted, trigger the BSR for the D2D communications.

Hence, the ProSe-BSR may be triggered or timely triggered, and the base station side may obtain or timely obtain data amounts of the D2D communications.

### Embodiment 14

An embodiment of this disclosure provides an apparatus for triggering a buffer status report (BSR), configured in user equipment. This embodiment corresponds to embodiments 11-12, with identical contents being not going to be described herein any further.

The apparatus for triggering a buffer status report of the embodiment of this disclosure is as shown in FIG. 34, and may include: a determining unit 3401 and a reporting unit 3402;

the determining unit 3401 is configured to determine, in a case where one or more radio bearer(s) of the user equipment based on a D2D communications mode are converted into radio access bearers based on an infrastructure mode and a resource allocation manner configured by a base station for the user equipment in D2D communications is a resource allocation manner based on base station scheduling, that the user equipment at least further has a radio bearer based on the D2D communications mode in which there exist available data to be transmitted;

and the reporting unit 3402 is configured to, in a case where the user equipment at least further has a radio bearer based on the D2D communications mode in which there exist available data to be transmitted, trigger a BSR for the D2D communications.

In this embodiment, the determining unit 3401 may further be configured to determine that the radio bearer based on the D2D communications mode belongs to the same logic channel group and/or the same D2D communications group as the at least one radio bearer based on the D2D communications mode to be converted;

and the reporting unit 3402 may further be configured to, in a case where the user equipment at least further has a radio bearer based on the D2D communications mode in which there exist available data to be transmitted and belonging to the same logic channel group and/or the same D2D communications group as the at least one radio bearer based on the D2D communications mode to be converted, trigger a BSR for the D2D communications.

Hence, the ProSe-BSR may be triggered or timely triggered, and the base station side may obtain or timely obtain data amounts of the D2D communications.

### Embodiment 15

An embodiment of this disclosure provides a communications system. FIG. 35 is a schematic diagram of a structure of the communications system of the embodiment of this disclosure. As shown in FIG. 35, the communications system 3500 includes a base station 3501 and UE 3502. The UE 3502 is configured with the apparatus 3400 for triggering a buffer status report as described in Embodiment 13 or Embodiment 14.

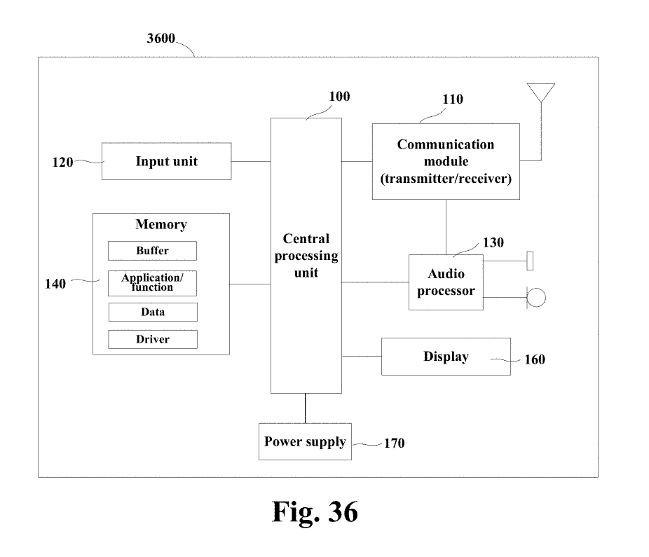

FIG. 36 is a block diagram of a systematic structure of the UE 3600 of the embodiment of this disclosure. As shown in FIG. 36, the UE 3600 may include a central processing unit 100 and a memory 140, the memory 140 being coupled to the central processing unit 100. It should be noted that this figure is illustrative only, and other types of structures may also be used, so as to supplement or replace this structure and achieve a telecommunications function or other functions.

In an implementation, the functions of the apparatus 3400 for triggering a buffer status report may be integrated into the central processing unit 100. The central processing unit 100 may be configured to carry out the method for triggering a buffer status report as described in embodiments 1-12.

In another implementation, the apparatus 3400 for triggering a buffer status report and the central processing unit 100 may be configured separately. For example, the apparatus 3400 for triggering a buffer status report may be configured as a chip connected to the central processing unit 100, with its functions being realized under control of the central processing unit 100.

In this embodiment, the central processing unit 100 may be configured to perform following control:

in a case where one or more radio access bearer(s) of the UE based on an infrastructure mode are converted into radio bearers based on a D2D communications mode, a resource allocation manner configured by a base station for the UE in D2D communications is a resource allocation manner based on base station scheduling, and there exist available data to be transmitted in a PDCP entity or an RLC entity to which at least one radio bearer in the one or more radio bearer(s) based on the D2D communications mode corresponds, triggering a BSR for the D2D communications;

or, in a case where one or more radio bearer(s) of the UE based on the D2D communications mode are converted into radio access bearers based on the infrastructure mode, a resource allocation manner configured by a base station for the UE in D2D communications is a resource allocation manner based on base station scheduling, and the UE at least further has a radio bearer based on the D2D communications mode in which there exist available data to be transmitted, triggering a BSR for the D2D communications.

In an implementation, in a case where one or more radio access bearer(s) of the UE based on an infrastructure mode are converted into radio bearers based on a D2D communications mode and a resource allocation manner configured by a base station for the UE in D2D communications is a resource allocation manner based on base station scheduling, the UE triggers a BSR for the D2D communications if the following conditions are satisfied:

there exist available data to be transmitted in a PDCP entity or an RLC entity to which at least one radio bearer based on the D2D communications mode corresponds, and the UE does not establish any radio bearer based on the D2D communications mode before the conversion;

or, there exist available data to be transmitted in a PDCP entity or an RLC entity to which at least one radio bearer based on the D2D communications mode corresponds, and the UE does not establish any radio bearer belonging to the same D2D communications group as the at least one radio bearer based on the D2D communications mode before the conversion;

or, there exist available data to be transmitted in a PDCP entity or an RLC entity to which at least one radio bearer based on the D2D communications mode corresponds, the UE does not establish any radio bearer belonging to the same D2D communications group as the at least one radio bearer based on the D2D communications mode before the conversion, and the priority of the D2D communications group to which the at least one radio bearer based on the D2D communications mode belongs is higher than that of any D2D communications group of radio bearers based on the D2D communications mode in which there at least exists one available datum to be transmitted.

In another implementation, in a case where one or more radio access bearer(s) of the UE based on an infrastructure mode are converted into radio bears based on a D2D communications mode and a resource allocation manner configured by a base station for the UE in D2D communications is a resource allocation manner based on base station scheduling, the UE triggers a BSR for the D2D communications if the following conditions are satisfied:

there exist available data to be transmitted in a PDCP entity or an RLC entity to which at least one radio bearer based on the D2D communications mode corresponds, and there exists no available datum to be transmitted in any radio bearer based on the D2D communications mode established by the UE before the conversion;

or there exist available data to be transmitted in a PDCP entity or an RLC entity to which at least one radio bearer based on the D2D communications mode corresponds, and there exists no available datum to be transmitted in any radio bearer belonging to the same D2D communications group as the at least one radio bearer based on the D2D communications mode established by the UE before the conversion;

or there exist available data to be transmitted in a PDCP entity or an RLC entity to which at least one radio bearer based on the D2D communications mode corresponds, there exists no available datum to be transmitted in any radio bearer belonging to the same D2D communications group as the at least one radio bearer based on the D2D communications mode established by the UE before the conversion, and the priority of the D2D communications group to which the at least one radio bearer based on the D2D communications mode belongs is higher than that of any D2D communications group of radio bearers based on the D2D communications mode in which there at least exists one available datum to be transmitted.

In a further implementation, in a case where one or more radio access bearer(s) of the UE based on an infrastructure mode are converted into radio bearers based on a D2D communications mode and a resource allocation manner configured by a base station for the UE in D2D communications is a resource allocation manner based on base station scheduling, the UE triggers a BSR for the D2D communications if the following conditions are satisfied:

there exist available data to be transmitted in a PDCP entity or an RLC entity to which at least one radio bearer based on the D2D communications mode corresponds, and a priority of a logic channel to which the at least one radio bearer based on the D2D communications mode corresponds is higher than that of a logic channel to which any radio bearer based on the D2D communications mode established by the UE before the conversion in which there exist available data to be transmitted corresponds;

or there exist available data to be transmitted in the PDCP entity or the RLC entity to which the at least one radio bearer based on the D2D communications mode corresponds and the priority of the logic channel to which the at least one radio bearer based on the D2D communications mode corresponds is higher than that of the logic channel to which any radio bearer based on the D2D communications mode established by the UE before the conversion in which there exist available data to be transmitted corresponds;

or there exist available data to be transmitted in the PDCP entity or the RLC entity to which the at least one radio bearer based on the D2D communications mode corresponds, the priority of the logic channel to which the at least one radio bearer based on the D2D communications mode corresponds is higher than that of the logic channel to which any radio bearer based on the D2D communications mode established by the UE before the conversion in which there exist available data to be transmitted corresponds, and the priority of the D2D communications group to which the at least one radio bearer based on the D2D communications mode belongs is higher than that of any D2D communications group of radio bearers based on the D2D communications mode in which there at least exists one available datum to be transmitted.

In a yet implementation, in a case where one or more radio bearer(s) of the UE based on an infrastructure mode are converted into radio access bearers based on a D2D communications mode and a resource allocation manner configured by a base station for the UE in D2D communications is a resource allocation manner based on base station scheduling, the UE triggers a BSR for the D2D communications if the following conditions are satisfied:

the UE at least further has a radio bearer based on the D2D communications mode in which there exist available data to be transmitted; and

the radio bearer based on the D2D communications mode belongs to the same logic channel group as the at least one radio bearer based on the D2D communications mode to be converted, and/or the radio bearer based on the D2D communications mode belongs to the same D2D communications group as the at least one radio bearer based on the D2D communications mode to be converted.

As shown in FIG. 36, the UE 3600 may further include a communications module 110, an input unit 120, an audio processor 130, a display 160 and a power supply 170. It should be appreciated that the UE 3600 does not necessarily include all the parts shown in FIG. 36, and furthermore, the UE 3600 may include parts not shown in FIG. 13, and the relevant art may be referred to.

As shown in FIG. 36, the central processing unit 100 is sometimes referred to as a controller or control, and may include a microprocessor or other processor devices and/or logic devices. The central processing unit 100 receives input and controls operations of every components of the UE 3600.

The memory 140 may be, for example, one or more of a buffer memory, a flash memory, a hard drive, a mobile medium, a volatile memory, a nonvolatile memory, or other suitable devices, which may store predefined or preconfigured information, and may further store a program executing related information. And the central processing unit 100 may execute the program stored in the memory 140, so as to realize information storage or processing, etc. Functions of other parts are similar to those of the relevant art, which shall not be described herein any further. The parts of the UE 1300 may be realized by specific hardware, firmware, software, or any combination thereof, without departing from the scope of the present disclosure.

An embodiment of the present disclosure provides a computer readable program code, which, when executed in UE, will cause a computer unit to carry out the methods for triggering a buffer status report as described in embodiments 1-12 in the UE.

An embodiment of the present disclosure provides a computer readable medium, including a computer readable program code, which will cause a computer unit to carry out the methods for triggering a buffer status report as described in embodiments 1-12 in UE.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communications combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An apparatus for triggering a buffer status report (BSR), configured in user equipment, the apparatus comprising:
a determining unit configured to, in a case where one or more radio access bearer(s) of the user equipment based on an infrastructure mode is(are) converted into radio bears based on a device to device (D2D) communications mode and a resource allocation manner configured by a base station for the user equipment in D2D communications is a resource allocation manner based on base station scheduling, determine that there exist available data to be transmitted in a packet data convergence protocol (PDCP) entity or a radio link control (RLC) entity to which at least one radio bearer in the one or more radio bearer(s) based on the D2D communications mode corresponds; and
a reporting unit configured to, in a case where there exist available data to be transmitted in the PDCP entity or the RLC entity to which the at least one radio bearer based on the D2D communications mode corresponds, trigger a BSR for the D2D communications.

2. The apparatus according to claim 1, wherein the determining unit is further configured to determine that the user equipment does not establish any radio bearer based on the D2D communications mode before the one or more radio access bearer(s) based on the infrastructure mode is(are) converted into radio bears based on the D2D communications mode;
and the reporting unit is further configured to, in a case where there exist available data to be transmitted in the PDCP entity or the RLC entity to which the at least one radio bearer based on the D2D communications mode corresponds and the user equipment does not establish any radio bearer based on the D2D communications mode before the conversion, trigger the BSR for the D2D communications.

3. The apparatus according to claim 1, wherein the determining unit is further configured to determine that the user equipment does not establish any radio bearer belonging to the same D2D communications group as the at least one radio bearer based on the D2D communications mode before the one or more radio access bearer(s) based on the infrastructure mode is(are) converted into radio bears based on the D2D communications mode;
and the reporting unit is further configured to, in a case where there exist available data to be transmitted in the PDCP entity or the RLC entity to which the at least one radio bearer based on the D2D communications mode corresponds and the user equipment does not establish any radio bearer belonging to the same D2D communications group as the at least one radio bearer based on the D2D communications mode before the conversion, trigger the BSR for the D2D communications.

4. The apparatus according to claim 3, wherein the determining unit is further configured to determine that a priority of the D2D communications group to which the at least one radio bearer based on the D2D communications mode belongs is higher than that of any D2D communications group of radio bearers based on the D2D communications mode in which there at least exists one available datum to be transmitted;
and the reporting unit is further configured to, in a case where there exist available data to be transmitted in the PDCP entity or the RLC entity to which the at least one radio bearer based on the D2D communications mode corresponds, the user equipment does not establish any radio bearer belonging to the same D2D communications group as the at least one radio bearer based on the D2D communications mode before the conversion, and the priority of the D2D communications group to which the at least one radio bearer based on the D2D communications mode belongs is higher than that of any D2D communications group of radio bearers based on the D2D communications mode in which there at least exists one available datum to be transmitted, trigger the BSR for the D2D communications.

5. The apparatus according to claim 1, wherein the determining unit is further configured to determine that before the one or more radio access bearer(s) of the user equipment based on an infrastructure mode is(are) converted into radio bears based on a D2D communications mode, there exists no available data to be transmitted in any radio bearer based on the D2D communications mode established by the user equipment;
and the reporting unit is further configured to, in a case where there exist available data to be transmitted in the PDCP entity or the RLC entity to which the at least one radio bearer based on the D2D communications mode corresponds and there exists no available data to be transmitted in any radio bearer based on the D2D communications mode established by the user equipment before the conversion, trigger the BSR for the D2D communications.

6. The apparatus according to claim 1, wherein the determining unit is further configured to determine that before the one or more radio access bearer(s) of the user equipment based on an infrastructure mode is(are) converted into radio bears based on a D2D communications mode, there exists no available data to be transmitted in any radio bearer belonging to the same D2D communications group as the at least one radio bearer based on the D2D communications mode established by the user equipment;
and the reporting unit is further configured to, in a case where there exists an available datum to be transmitted in the PDCP entity or the RLC entity to which the at least one radio bearer based on the D2D communications mode corresponds and there exists no available data to be transmitted in any radio bearer belonging to the same D2D communications group as the at least one radio bearer based on the D2D communications mode established by the user equipment before the conversion, trigger the BSR for the D2D communications.

7. The apparatus according to claim 6, wherein the determining unit is further configured to determine that a priority of the D2D communications group to which the at least one radio bearer based on the D2D communications mode belongs is higher than that of any D2D communications group of radio bearers based on the D2D communications mode in which there at least exists one available datum to be transmitted;
and the reporting unit is further configured to, in a case where there exists an available datum to be transmitted in the PDCP entity or the RLC entity to which the at least one radio bearer based on the D2D communications mode corresponds, there exists no available data to be transmitted in any radio bearer belonging to the same D2D communications group as the at least one radio bearer based on the D2D communications mode established by the user equipment before the conversion, and the priority of the D2D communications group to which the at least one radio bearer based on the D2D communications mode belongs is higher than that of any D2D communications group of radio bearers based on the D2D communications mode in which there at least exists one available datum to be transmitted, trigger the BSR for the D2D communications.

8. The apparatus according to claim 1, wherein the determining unit is further configured to determine that a priority of a logic channel to which the at least one radio bearer based on the D2D communications mode corresponds is higher than that of a logic channel to which any radio bearer based on the D2D communications mode established by the user equipment before the conversion in which there exists available data to be transmitted corresponds;
and the reporting unit is further configured to, in a case where there exist available data to be transmitted in the PDCP entity or the RLC entity to which the at least one radio bearer based on the D2D communications mode corresponds and the priority of the logic channel to which the at least one radio bearer based on the D2D communications mode corresponds is higher than that of the logic channel to which any radio bearer based on the D2D communications mode established by the user equipment before the conversion in which there exist available data to be transmitted corresponds, trigger the BSR for the D2D communications.

9. The apparatus according to claim 1, wherein the determining unit is further configured to determine that a priority of a logic channel to which the at least one radio bearer based on the D2D communications mode corresponds is higher than that of a logic channel to which a radio bearer based on the D2D communications mode established by the user equipment before the conversion belonging to the same D2D communications group as the at least one radio bearer based on the D2D communications mode and in which there exist available data to be transmitted corresponds;
and the reporting unit is further configured to, in a case where there exist available data to be transmitted in the PDCP entity or the RLC entity to which the at least one radio bearer based on the D2D communications mode corresponds and the priority of a logic channel to which the at least one radio bearer based on the D2D communications mode corresponds is higher than that of a logic channel to which a radio bearer based on the D2D communications mode established by the user equipment before the conversion belonging to the same D2D communications group as the at least one radio bearer based on the D2D communications mode and in which there exist available data to be transmitted corresponds, trigger the BSR for the D2D communications.

10. The apparatus according to claim 9, wherein the determining unit is further configured to determine that a priority of the D2D communications group to which the at least one radio bearer based on the D2D communications mode belongs is higher than that of any D2D communications group of radio bearers based on the D2D communications mode in which there at least exists one available datum to be transmitted;
and the reporting unit is further configured to, in a case where there exist available data to be transmitted in the PDCP entity or the RLC entity to which the at least one radio bearer based on the D2D communications mode corresponds, the priority of the logic channel to which the at least one radio bearer based on the D2D communications mode corresponds is higher than that of the logic channel to which the radio bearer based on the D2D communications mode established by the user equipment before the conversion belonging to the same D2D communications group as the at least one radio bearer based on the D2D communications mode and in which there exist available data to be transmitted corresponds, and the priority of the D2D communications group to which the at least one radio bearer based on the D2D communications mode belongs is higher than that of any D2D communications group of radio bearers based on the D2D communications mode in which there at least exists one available datum to be transmitted, trigger the BSR for the D2D communications.

11. An apparatus for triggering a buffer status report (BSR), configured in user equipment, the apparatus comprising:
a determining unit configured to determine, in a case where one or more radio bearer(s) of the user equipment based on a D2D communications mode is(are) converted into radio access bearers based on an infrastructure mode and a resource allocation manner configured by a base station for the user equipment in D2D communications is a resource allocation manner based on base station scheduling, that the user equipment at least further has a radio bearer based on the D2D communications mode in which there exist available data to be transmitted; and
a reporting unit configured to, in a case where the user equipment at least further has a radio bearer based on the D2D communications mode in which there exist available data to be transmitted, trigger a BSR for the D2D communications.

12. The apparatus according to claim 11, wherein the determining unit is further configured to determine that the radio bearer based on the D2D communications mode belongs to the same logic channel group and/or the same D2D communications group as the at least one radio bearer based on the D2D communications mode to be converted;
and the reporting unit is further configured to, in a case where the user equipment at least further has a radio bearer based on the D2D communications mode in which there exist available data to be transmitted and belonging to the same logic channel group and/or the same D2D communications group as the at least one radio bearer based on the D2D communications mode to be converted, trigger a BSR for the D2D communications.

13. A communications system, comprising:
user equipment configured to, in a case where one or more radio access bearer(s) of the user equipment based on an infrastructure mode is(are) converted into radio bearers based on a D2D communications mode, a resource allocation manner configured by a base station for the user equipment in D2D communications is a resource allocation manner based on base station scheduling, and there exist available data to be transmitted in a PDCP entity or an RLC entity to which at least one radio bearer in the one or more radio bearer(s) based on the D2D communications mode corresponds, trigger a BSR for the D2D communications;
or, in a case where one or more radio bearer(s) of the user equipment based on the D2D communications mode is(are) converted into radio access bearers based on the infrastructure mode, a resource allocation manner configured by a base station for the user equipment in D2D communications is a resource allocation manner based on base station scheduling, and the user equipment at least further has a radio bearer based on the D2D communications mode in which there exist available data to be transmitted, trigger a BSR for the D2D communications.

14. The communications system according to claim 13, wherein in a case where one or more radio access bearer(s) of the user equipment based on an infrastructure mode is(are) converted into radio bearers based on a D2D communications mode and a resource allocation manner configured by a base station for the user equipment in D2D communications is a resource allocation manner based on base station scheduling, the user equipment triggers a BSR for the D2D communications if the following conditions are satisfied:
there exist available data to be transmitted in a PDCP entity or an RLC entity to which at least one radio bearer based on the D2D communications mode corresponds, and the user equipment does not establish any radio bearer based on the D2D communications mode before the conversion;
or, there exist available data to be transmitted in a PDCP entity or an RLC entity to which at least one radio bearer based on the D2D communications mode corresponds, and the user equipment does not establish any radio bearer belonging to the same D2D communications group as the at least one radio bearer based on the D2D communications mode before the conversion;
or, there exist available data to be transmitted in a PDCP entity or an RLC entity to which at least one radio bearer based on the D2D communications mode corresponds, the user equipment does not establish any radio bearer belonging to the same D2D communications group as the at least one radio bearer based on the D2D communications mode before the conversion, and the priority of the D2D communications group to which the at least one radio bearer based on the D2D communications mode belongs is higher than that of any D2D communications group of radio bearers based on the D2D communications mode in which there at least exists one available datum to be transmitted.

15. The communications system according to claim 13, wherein in a case where one or more radio access bearer(s) of the user equipment based on an infrastructure mode is(are) converted into radio bears based on a D2D communications mode and a resource allocation manner configured by a base station for the user equipment in D2D communications is a resource allocation manner based on base station scheduling, the user equipment triggers a BSR for the D2D communications if the following conditions are satisfied:
there exist available data to be transmitted in a PDCP entity or an RLC entity to which at least one radio bearer based on the D2D communications mode corresponds, and there exists no available datum to be transmitted in any radio bearer based on the D2D communications mode established by the user equipment before the conversion;
or there exist available data to be transmitted in a PDCP entity or an RLC entity to which at least one radio bearer based on the D2D communications mode corresponds, and there exists no available datum to be transmitted in any radio bearer belonging to the same D2D communications group as the at least one radio bearer based on the D2D communications mode established by the user equipment before the conversion;
or there exist available data to be transmitted in a PDCP entity or an RLC entity to which at least one radio bearer based on the D2D communications mode corresponds, there exists no available datum to be transmitted in any radio bearer belonging to the same D2D communications group as the at least one radio bearer based on the D2D communications mode established by the user equipment before the conversion, and the priority of the D2D communications group to which the at least one radio bearer based on the D2D communications mode belongs is higher than that of any D2D communications group of radio bearers based on the D2D communications mode in which there at least exists one available datum to be transmitted.

16. The communications system according to claim 13, wherein in a case where one or more radio access bearer(s) of the user equipment based on an infrastructure mode is(are) converted into radio bearers based on a D2D communications mode and a resource allocation manner configured by a base station for the user equipment in D2D communications is a resource allocation manner based on base station scheduling, the user equipment triggers a BSR for the D2D communications if the following conditions are satisfied:
there exist available data to be transmitted in a PDCP entity or an RLC entity to which at least one radio bearer based on the D2D communications mode corresponds, and a priority of a logic channel to which the at least one radio bearer based on the D2D communications mode corresponds is higher than that of a logic channel to which any radio bearer based on the D2D communications mode established by the user equipment before the conversion in which there exist available data to be transmitted corresponds;
or there exist available data to be transmitted in the PDCP entity or the RLC entity to which the at least one radio bearer based on the D2D communications mode corresponds and the priority of the logic channel to which the at least one radio bearer based on the D2D communications mode corresponds is higher than that of the logic channel to which any radio bearer based on the D2D communications mode established by the user equipment before the conversion in which there exist available data to be transmitted corresponds;
or there exist available data to be transmitted in the PDCP entity or the RLC entity to which the at least one radio bearer based on the D2D communications mode corresponds, the priority of the logic channel to which the at least one radio bearer based on the D2D communications mode corresponds is higher than that of the logic channel to which any radio bearer based on the D2D communications mode established by the user equipment before the conversion in which there exist available data to be transmitted corresponds, and the priority of the D2D communications group to which the at least one radio bearer based on the D2D communications mode belongs is higher than that of any D2D communications group of radio bearers based on the D2D communications mode in which there at least exists one available datum to be transmitted.

17. The communications system according to claim 13, wherein in a case where one or more radio bearer(s) of the user equipment based on an infrastructure mode is(are) converted into radio access bearers based on a D2D communications mode and a resource allocation manner configured by a base station for the user equipment in D2D communications is a resource allocation manner based on base station scheduling, the user equipment triggers a BSR for the D2D communications if the following conditions are satisfied:
the user equipment at least further has a radio bearer based on the D2D communications mode in which there exist available data to be transmitted; and
the radio bearer based on the D2D communications mode belongs to the same logic channel group as the at least one radio bearer based on the D2D communications mode to be converted, and/or the radio bearer based on the D2D communications mode belongs to the same D2D communications group as the at least one radio bearer based on the D2D communications mode to be converted.
